(19) United States
(12) Patent Application Publication
(10) Pub. No.: US 2023/0322168 A1
(43) Pub. Date: Oct. 12, 2023

(54) Vehicle Storage Apparatus and System

(71) Applicants: Jesse Shimp, Jacksonville, FL (US); Trevor Lee, Jacksonville, FL (US)

(72) Inventors: Jesse Shimp, Jacksonville, FL (US); Trevor Lee, Jacksonville, FL (US)

(21) Appl. No.: 18/209,467

(22) Filed: Jun. 13, 2023

Related U.S. Application Data
(63) Continuation-in-part of application No. 17/490,459, filed on Sep. 30, 2021, now Pat. No. 11,713,002.
(60) Provisional application No. 63/085,923, filed on Sep. 30, 2020.

(51) Int. Cl. B60R 11/06; B60R 9/06

(52) U.S. Cl. CPC B60R 11/06; B60R 9/065

(57) ABSTRACT

The present disclosure provides generally for systems, methods, and apparatus for more effectively storing and accessing contents in a truck bed. A storage apparatus may comprise a lid and a container. One or more brackets, panels, storage trays, or other accessories may be modularly configured within the container or upon an interior surface of the lid, which may allow for customization and organization. The storage apparatus may comprise at least one electronic locking mechanism, allowing for convenient access to the container while also providing security. The storage apparatus may comprise a self-contained electronic system that comprises at least one controller and at least one power source to facilitate use of the electronic locking mechanism, one or more lighting mechanisms, or other electronic features. The storage apparatus may be at least temporarily secured to at least a portion of a vehicle via at least one clamping bracket.

### CROSS-REFERENCE TO RELATED APPLICATION

This application is a continuation in part of and claims priority to U.S. Nonprovisional patent application Ser. No. 17/490,459, filed Sep. 30, 2021, and titled “VEHICLE STORAGE APPARATUS AND SYSTEM”, which claimed priority to and the full benefit of U.S. Provisional Patent Application Ser. No. 63/085,923, filed Sep. 30, 2020, and titled “TRUCK TOOLBOX APPARATUS AND SYSTEM”, the entire contents of which are incorporated in this application by reference.

### BACKGROUND

The trunk is typically a vehicle's main storage or cargo compartment. While in the 17^{th} century this was originally located at the side of a stagecoach, by the 19^{th} century this trunk location shifted depending on where the vehicle's engine was located. The use of the trunk has evolved over time, being used to accommodate passenger materials such as luggage to emergency supplies like a spare tire or emergency aid kit. By 1950, the manufacturer Ford introduced a trigger catch to allow for one-hand lifting, increasing the convenience of using a trunk for a vehicle's users. As vehicle design evolved, so did the types of vehicles, such as trucks.

Originally, trucks were developed to aid in industry and logistics, with multiple classifications for different truck types. Compared to smaller cars, trucks allowed companies to move equipment and materials. Trucks launched efficiency in many industries, such as farming, delivery services, and construction. Additionally, trucks allowed for portable servicing where a service provider could visit work sites with the necessary materials and equipment.

As trucks have evolved, so have its drivers. Motivations for owning a truck vary today. Some may drive a truck based on storage and transportation needs, such as for a construction company, an installation company, or delivery company. Some may drive a truck based on terrain, such as driving through mud, rocks, construction sites, or inclines. Within the last few decades, trucks have gained popularity for those who simply like trucks, expanding beyond commercial drivers. For example, the pickup truck is a popular vehicle for those who like to complement usability with off-road capabilities.

Generally, trucks are highly customizable, including options for lift, tires, truck bed capacity, and passenger capacity. Many truck drivers customize their trucks to their exact needs and preferences. Truck drivers typically purchase toolboxes for their vehicles, which is typically defined as a box that fits into a truck bed. Traditionally, toolboxes are built with a generic design that includes an open container encapsulated by a lid secured by a lock and key. This lack of diversity in composition limits the potential functionality of the toolbox. The manufacturers offer little customization and the usability of the space within the container is limited to the intended storage of tools and similar materials. Despite the form factor of a truck allowing for different storage variations, owners are normally limited to toolboxes if they want a compartmentalized space to store their belongings.

As a result, there is a lack of variability in design and functionality limits the growing needs of the increasingly diverse consumer population. Owners of larger vehicles, particularly those with an open storage space like in a truck, may need something beyond the standard storage box to meet their needs. A person's needs may shift depending on what a person wants to do, and the current market options need to be able to adjust to those changing wants.

### SUMMARY OF THE DISCLOSURE

Therefore, what is needed is a variable, configurable, or adaptable system, method, and device for storing and accessing contents in a vehicle, particularly a truck bed. Many drivers have professional roles where the rugged and rudimentary design of the standard toolbox does not address their needs. Generally, a storage apparatus is provided that may comprise a lid and a container. According to the present disclosure, the device may comprise a storage apparatus that may cater to the unique needs of each driver or driver type.

In some aspects, one or more brackets, panels, storage trays, or other accessories may be modularly configured within the container or upon an interior surface of the lid, which may allow for customization and organization. In some implementations, one or more interior portions of the container or the lid may at least partially comprise an amount of insulating, rigidity-enhancing, or sound dampening material. In some embodiments, one or more interior surfaces of the container or the lid may comprise one or more object securing locations configured to at least temporarily secure one or more objects, items, structures, or devices. In some implementations, the storage apparatus may comprise at least one electronic locking mechanism, which may allow for convenient and secure access to the container. In some aspects, the storage apparatus may be configurable based on user needs and preferences. in some embodiments, the storage apparatus may comprise a self-contained electronic system that comprises at least one controller and at least one power source to facilitate use of the electronic locking mechanism, one or more lighting mechanisms, or other electronic features. The storage apparatus may be at least temporarily secured to at least a portion of a vehicle via at least one clamping bracket.

The present disclosure relates to a storage apparatus configured to fit within a rear portion of a vehicle. In some embodiments, the storage apparatus may comprise a container comprising a base, at least three side panels, and a substantially open top portion, wherein a lid may be configured to be altered between an open position and a closed position, wherein the lid may be configured to cover the substantially open top portion when in the closed position.

In some implementations, an outer surface of one or more portions of the storage apparatus may comprise at least one type of variable surface or protruding structure. In some aspects, the at least one protruding structure may comprise at least one of a bump, a point, a ridge, a raised edge, and a raised panel. In some aspects, the container may comprise four side panels; wherein the lid may be attached to an upper portion of the container via at least one hinge; and wherein an outer surface of the lid may comprise a plurality of bumps and at least two raised panels. In some embodiments, the lid and the container may comprise angled corners and a front portion of the lid may comprise a substantially planar tab extending downwardly therefrom.

In some implementations, the storage apparatus may comprise one or more of: an amount of insulating material, an amount of rigidity-enhancing material, an amount of sound dampening material, a storage apparatus securing device, a power source, a lighting mechanism, an object securing mechanism, an electrical port, and a securing system. In some embodiments, the securing system may comprise at least one of: a key lock, a combination lock, and an electronic locking system. In some implementations, the electronic locking system may be directed by an external signal device.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates an exemplary closed storage apparatus, according to some embodiments of the present disclosure.

FIG. 1B illustrates an exemplary closed storage apparatus, according to some embodiments of the present disclosure.

FIG. 1C illustrates an exemplary closed storage apparatus, according to some embodiments of the present disclosure.

FIG. 1D illustrates an exemplary closed storage apparatus, according to some embodiments of the present disclosure.

FIG. 1E illustrates an exemplary closed storage apparatus, according to some embodiments of the present disclosure.

FIG. 1F illustrates an exemplary closed storage apparatus, according to some embodiments of the present disclosure.

FIG. 1G illustrates an exemplary closed storage apparatus, according to some embodiments of the present disclosure.

FIG. 1H illustrates an exemplary closed storage apparatus, according to some embodiments of the present disclosure.

FIG. 1I illustrates an exemplary open storage apparatus, according to some embodiments of the present disclosure.

FIG. 1J illustrates an exemplary open storage apparatus, according to some embodiments of the present disclosure.

FIG. 1K illustrates an exemplary open storage apparatus, according to some embodiments of the present disclosure.

FIG. 2 illustrates an exemplary interior of the container, according to some embodiments of the present disclosure.

FIG. 3A illustrates an exemplary storage apparatus secured within a vehicle, according to some embodiments of the present disclosure.

FIG. 3B illustrates an exemplary storage apparatus secured within a vehicle, according to some embodiments of the present disclosure.

FIG. 3C illustrates an exemplary storage apparatus secured within a vehicle, according to some embodiments of the present disclosure.

FIG. 4A illustrates exemplary sub-containers within a storage apparatus, according to some embodiments of the present disclosure.

FIG. 4B illustrates exemplary sub-containers within a storage apparatus, according to some embodiments of the present disclosure.

FIG. 5 illustrates exemplary sub-containers within a storage apparatus, according to some embodiments of the present disclosure, according to some embodiments of the present disclosure.

FIG. 6A illustrates exemplary interior dividers within the storage apparatus, according to some embodiments of the present disclosure.

FIG. 6B illustrates exemplary interior dividers within the storage apparatus, according to some embodiments of the present disclosure.

FIG. 7A illustrates exemplary sub-containers within the storage apparatus, according to some embodiments of the present disclosure.

FIG. 7B illustrates exemplary sub-containers within the storage apparatus, according to some embodiments of the present disclosure.

FIG. 8A illustrates exemplary sub-containers within the storage apparatus, according to some embodiments of the present disclosure.

FIG. 8B illustrates exemplary sub-containers within the storage apparatus, according to some embodiments of the present disclosure.

FIG. 8C illustrates exemplary sub-containers within the storage apparatus, according to some embodiments of the present disclosure.

FIG. 9 illustrates an exemplary embodiment of sub-containers within the storage apparatus, according to some embodiments of the present disclosure.

FIG. 10A illustrates exemplary sub-containers within the storage apparatus and lid configurations, according to some embodiments of the present disclosure.

FIG. 10B illustrates exemplary sub-containers within the storage apparatus and lid configurations, according to some embodiments of the present disclosure.

FIG. 10C illustrates an exemplary container with extendable truck bed panel, according to some embodiments of the present disclosure.

FIG. 11A illustrates exemplary lid configurations, according to some embodiments of the present disclosure.

FIG. 11B illustrates exemplary lid configurations, according to some embodiments of the present disclosure.

FIG. 11C illustrates exemplary lid configurations, according to some embodiments of the present disclosure.

FIG. 12A illustrates exemplary interior securing locations within the storage apparatus and alteration of the container side panels, according to some embodiments of the present disclosure.

FIG. 12B illustrates exterior securing locations, according to some embodiments of the present disclosure.

FIG. 12C illustrates exterior securing locations, according to some embodiments of the present disclosure.

FIG. 13A illustrates exemplary interior securing locations within the storage apparatus and alteration of the container side panels, according to some embodiments of the present disclosure.

FIG. 13B illustrates exterior securing locations, according to some embodiments of the present disclosure.

FIG. 13C illustrates exterior securing locations, according to some embodiments of the present disclosure.

FIG. 14A illustrates exemplary exterior securing locations, according to some embodiments of the present disclosure.

FIG. 14B illustrates an exemplary exterior securing panel, according to some embodiments of the present disclosure.

FIG. 14C illustrates an exemplary exterior securing panel, according to some embodiments of the present disclosure.

FIG. 14D illustrates an exemplary exterior securing panel, according to some embodiments of the present disclosure.

FIG. 14E illustrates an exemplary exterior securing panel, according to some embodiments of the present disclosure.

FIG. 15A illustrates exemplary energy collecting devices connected to the lid, according to some embodiments of the present disclosure.

FIG. 15B illustrates exemplary energy collecting devices connected to the lid, according to some embodiments of the present disclosure.

FIG. 15C illustrates exemplary energy collecting devices connected to the lid, according to some embodiments of the present disclosure.

FIG. 16A illustrates an exemplary securing system between a storage apparatus and an external signal device, according to some embodiments of the present disclosure.

FIG. 16B illustrates an exemplary securing system between a storage apparatus and an external signal device, according to some embodiments of the present disclosure.

FIG. 17A illustrates an exemplary altering storage apparatus configuration utilizing an external signal device, according to some embodiments of the present disclosure.

FIG. 17B illustrates an exemplary adjustable storage apparatus utilizing an external signal device, according to some embodiments of the present disclosure.

FIG. 17C illustrates an exemplary adjustable storage apparatus utilizing an external signal device, according to some embodiments of the present disclosure.

FIG. 18A illustrates an exemplary storage apparatus with a lid in an open position, according to some embodiments of the present disclosure.

FIG. 18B illustrates an exemplary storage apparatus with a lid in an open position, according to some embodiments of the present disclosure.

FIG. 18C illustrates a top view of an exemplary storage apparatus with a lid in an open position, according to some embodiments of the present disclosure.

FIG. 18D illustrates a front view of an exemplary storage apparatus with a lid in an open position, according to some embodiments of the present disclosure.

FIG. 18E illustrates a bottom view of an exemplary storage apparatus, according to some embodiments of the present disclosure.

FIG. 18F illustrates a side view of an exemplary storage apparatus with a lid in a closed position, according to some embodiments of the present disclosure.

FIG. 18G illustrates an exemplary lid of a storage apparatus with an integrated input device, according to some embodiments of the present disclosure.

FIG. 18H illustrates an exemplary clamp bracket for a storage apparatus, according to some embodiments of the present disclosure.

FIG. 18I illustrates an exemplary clamp bracket for a storage apparatus, according to some embodiments of the present disclosure.

FIG. 18J illustrates a side view of an exemplary clamp bracket for a storage apparatus, according to some embodiments of the present disclosure.

FIG. 18K illustrates a side view of an exemplary clamp bracket for a storage apparatus, according to some embodiments of the present disclosure.

FIG. 18L illustrates a top view of an exemplary clamp bracket for a storage apparatus, according to some embodiments of the present disclosure.

FIG. 18M illustrates a bottom view of an exemplary clamp bracket for a storage apparatus, according to some embodiments of the present disclosure.

### DETAILED DESCRIPTION

The present disclosure provides generally for systems, methods, and devices for a storage apparatus comprising of interchangeable subcomponents that are designed for specific utility. According to the present disclosure, a storage apparatus may consist of multiple subcomponents that may be included as a part of the storage apparatus for a variety of intended utility. For example, a storage apparatus may contain sub-containers with different intended uses. A sub-container may possess insulation sufficient to regulate temperature and provide protection for a laptop.

In some aspects, a sub-container may be supplied from a manufacturer. For example, a sub-container may be an insulated cooler from a vendor. In some implementations, a storage apparatus may possess external aids for movement. For example, a storage apparatus may collapse when relocated. In some embodiments, the storage apparatus may possess wheels to improve mobility. In some aspects, a storage apparatus container may contain holes intended for ease in securing the storage apparatus in a variety of positions.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Storage apparatus: as used herein refers to a container and lid designed to fit in the rear portion of a vehicle.
Container: as used herein refers to a containing portion of a storage apparatus.
Subcomponent: as used herein refers to internal or external portions of storage apparatus that provide added functionality. For example, subcomponents may comprise racks, sub-containers, or partitions, as non-limiting examples.

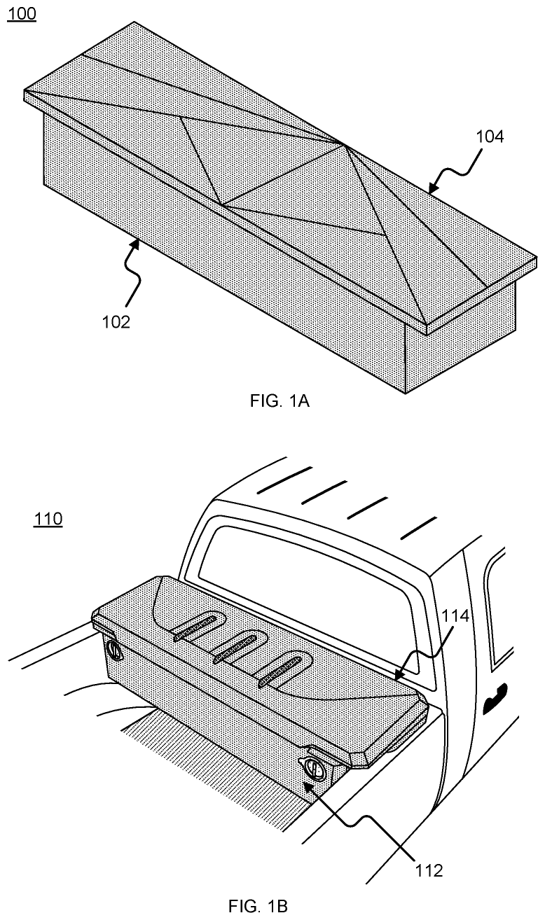

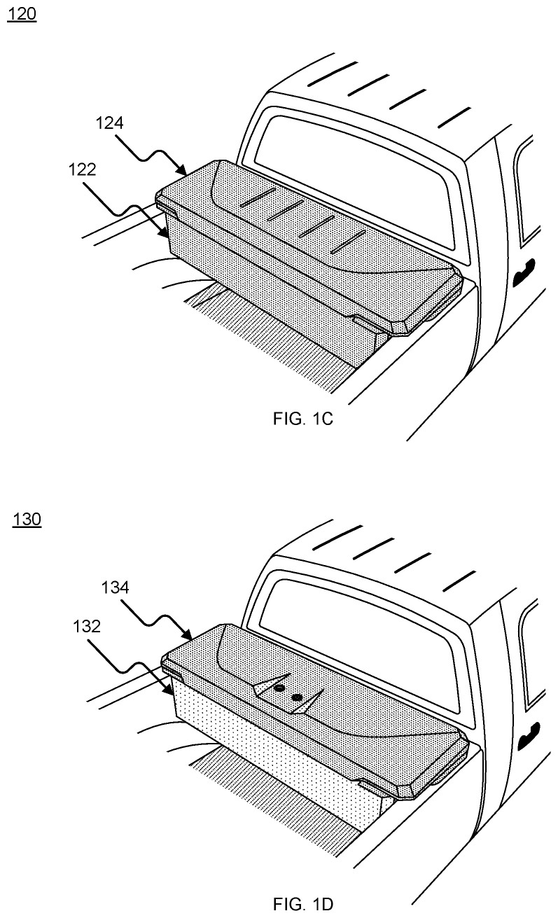

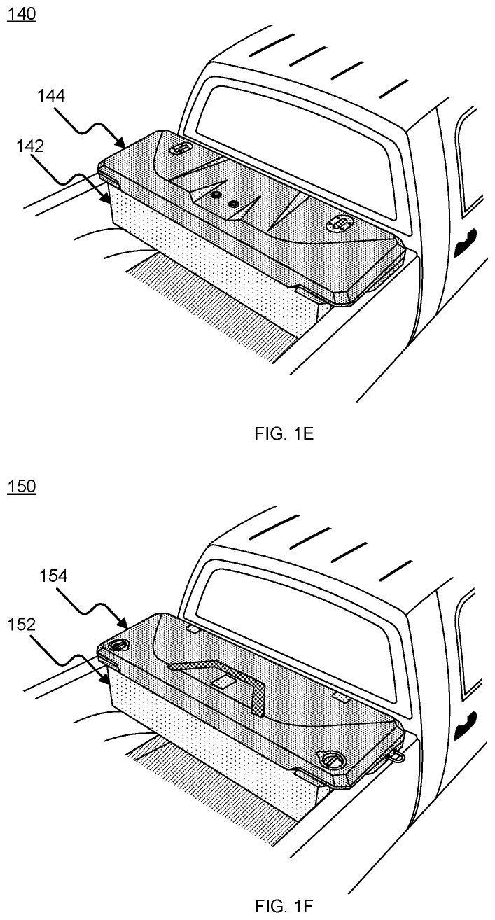

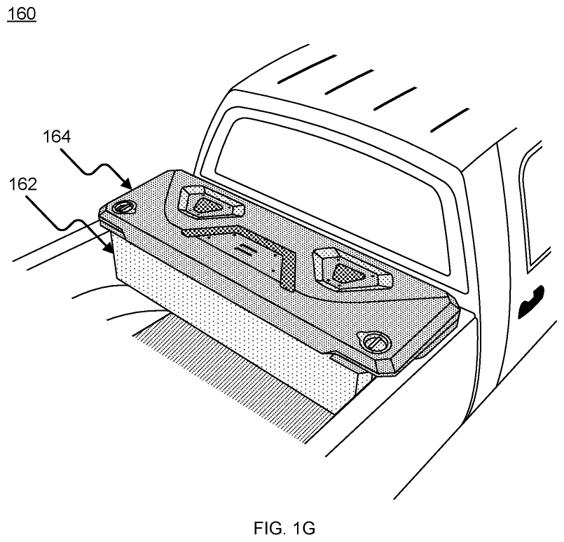

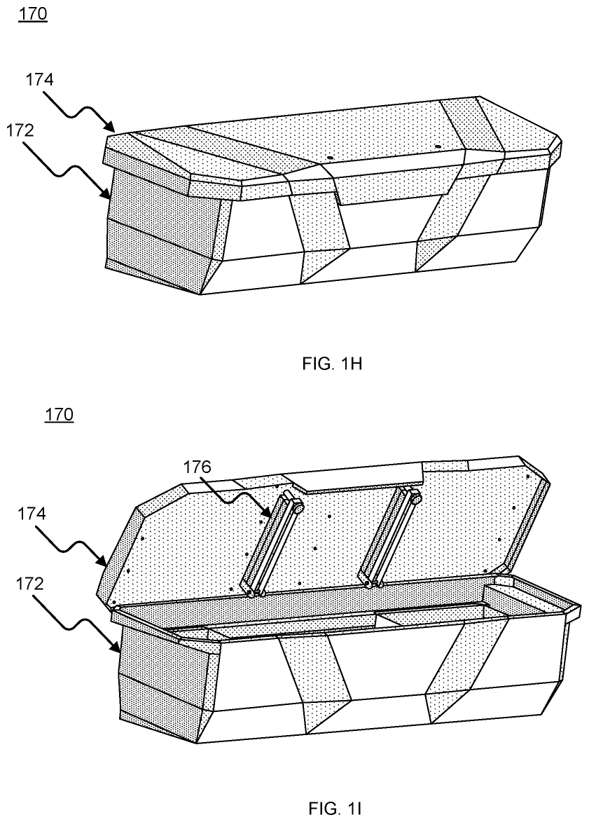

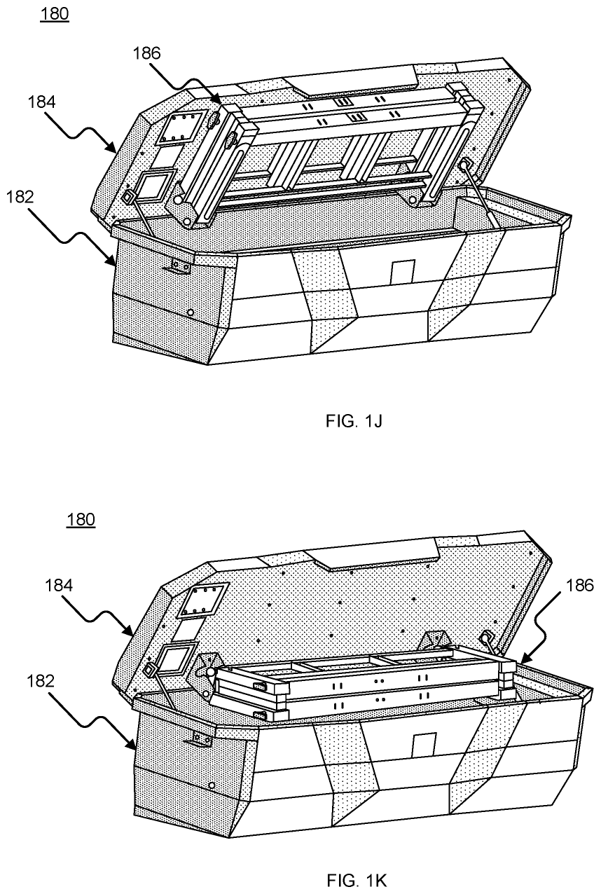

Referring now to FIGS. 1A-1K, an exemplary storage apparatus 100, 110, 120, 130, 140, 150, 160, 170, 180 is illustrated. The storage apparatus 100, 110, 120, 130, 140, 150, 160, 170, 180 may comprise a lid 104, 114, 124, 134, 144, 154, 164, 174, 184 and a container 102, 112, 122, 132, 142, 152, 162, 172, 182. In some aspects, the container 102, 112, 122, 132, 142, 152, 162, 172, 182 may comprise a base and at least three side panels. In some embodiments, the lid 104, 114, 124, 134, 144, 154, 164, 174, 184 may comprise a variable surface, which may increase durability and limit damage to the lid 104, 114, 124, 134, 144, 154, 164, 174, 184. By way of example and not limitation, the lid 104, 114, 124, 134, 144, 154, 164, 174, 184 may comprise an outer surface with at least one type of variable surface or protruding structure, such as a bump, point, ridge, raised edge, raised panel, or combination thereof.

In some aspects, an uneven surface may deflect contact and decrease the potential force of the object. In some implementations, the lid 104, 114, 124, 134, 144, 154, 164, 174, 184 may align flush with the surface of the container 102, 112, 122, 132, 142, 152, 162, 172, 182. The storage apparatus 110 may be reinforced with at least one reinforcement mechanism configured within an internal portion of the lid 104, 114, 124, 134, 144, 154, 164, 174, 184 or on an inner surface of the lid 104, 114, 124, 134, 144, 154, 164, 174, 184, which may allow for better protection of the lid 110 and the contents of the storage apparatus. For example, internal reinforcement of the lid 104, 114, 124, 134, 144, 154, 164, 174, 184 may insulate the storage apparatus 100, 110, 120, 130, 140, 150, 160, 170, 180 allowing for temperature control, such as through foam or cooling material. As another example, reinforcement may pair with the variable surface to further increase durability. The lid 104, 114, 124, 134, 144, 154, 164, 174, 184 may comprise a reinforcement mechanism in the form of an internal support structure, such as a lattice, frame, reinforcing bars, or combinations, as non-limiting examples.

In some embodiments, storage apparatus 170, 180 may comprise four side panels and a lid 174, 184 attached to an upper portion of the container 172, 182 via at least one hinge. In some implementations, the outer surface of the lid may comprise a plurality of protruding structures in the form of bumps as well as at least two raised panels, while the inner surface of the lid 174 may comprise at least one folding rack bar 176, 186, such as for accessories. For example, as illustrated in FIGS. 1J-1K, the folding rack bar 186 may be collapsible, allowing for storage of the rack bar 186 when not in use.

Additionally, at least one of the corners of the lid 174, 184 and the container 172, 182 may be angled. In some aspects, the lid 174 may include a substantially planar tab extending downwardly from a front portion of the lid 174. In some embodiments, the lid 174 may comprise interior insulation, which may limit heat loss or gain.

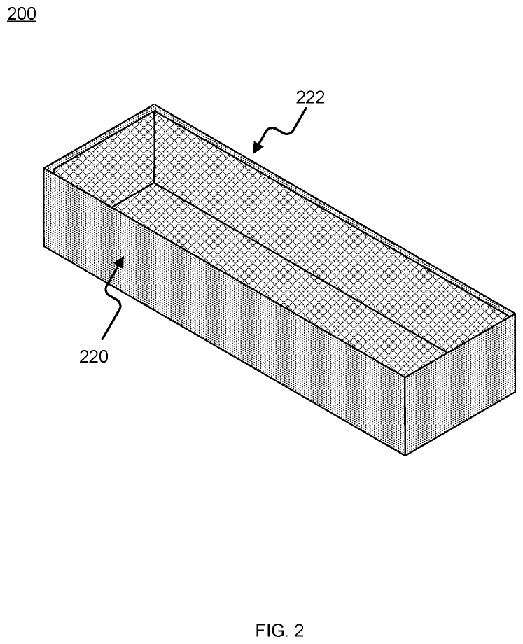

Referring now to FIG. 2, an exemplary interior of the container 220 is illustrated. In some implementations, the interior may contain padded insulation 221. In some embodiments, the insulation 221 may be removable from the container. In some aspects, the insulation 221 may be segmented for partial removal from the container. For example, a non-insulated segment of the container 220 may store items such as work boots or tools that may contain dirt, and an insulated segment of the container 220 may store a suit jacket and laptop, which may be fragile and clean. In some embodiments, this segment of the container 220 that may store dirty items may have the insulation 221 removed to prevent the insulation from collecting dirt.

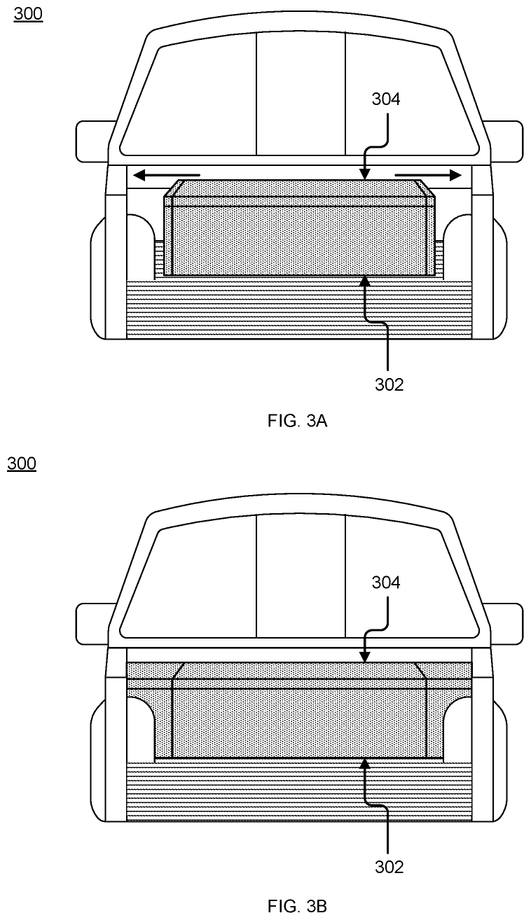

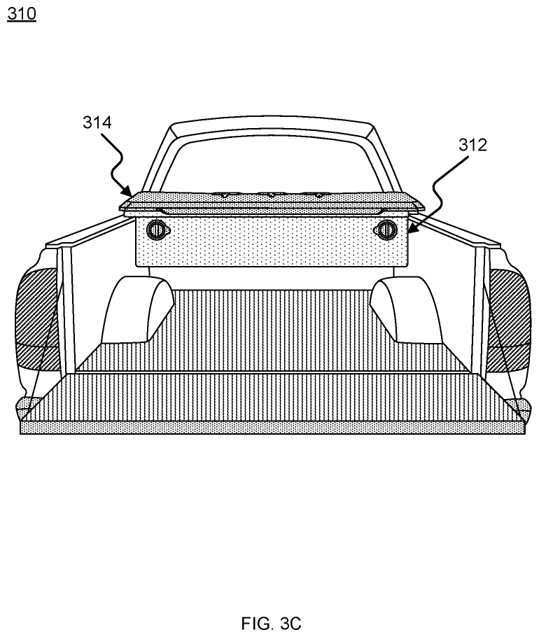

Referring now to FIG. 3A, an exemplary fitted storage apparatus 300 placed within the rear of a vehicle is illustrated. In some aspects, a fitted storage apparatus 300 may possess geometric parameters that differ from the intended placement within the vehicle. Referring now to FIG. 3B, an exemplary storage apparatus fitted to the vehicle is illustrated. In some embodiments, the fitted storage apparatus 300 may expand to meet the dimensions of the desired installation location within the vehicle, such as, for example and not limitation, by adjusting one or more of the side panels. In some aspects, the side panels may alter shape in a manner to fit over extruded features within the vehicle such as wheel wells, as a non-limiting example. In some implementations, the fitted storage apparatus 300 may be oriented at any depth of the vehicle. For example, the fitted storage apparatus 300 may be secured at the innermost face of a truck bed and could be relocated to the outermost edge of the truck bed.

In some implementations, the fitted storage apparatus 300 may be attached to the vehicle by means of an external storage apparatus securing device. For example, a clamp may apply pressure between the storage apparatus and both sides of the vehicle. In some aspects, the external storage apparatus securing device may contain components that are integrated with the structure of the container 302. In some embodiments, the fitted storage apparatus 300 may possess a rack and pinion structure that, controlled by a central knob, would extend stabilizing bars horizontally until adequate force was applied to the sides of the vehicle to reduce movement of the fitted storage apparatus 300.

Referring now to FIG. 3C, an exemplary floating storage apparatus 310 installed on a truck bed is illustrated. In some aspects, a floating storage apparatus 310 may fit over the edges of a truck bed, which may allow for use with a range of widths of truck beds. In some embodiments, a floating storage apparatus container 312 may not sit on the floor of a truck bed, which may allow for extended storage of objects within the truck bed.

In some implementations, the storage apparatus 300 may possess storage apparatus securing devices in the form of hollow cavities, holes, extruded anchors, as a non-limiting list, that may be utilized with additional securing devices to secure the storage apparatus 300 within the vehicle. In some aspects, an external storage apparatus securing device may provide a securing interface between the storage apparatus and the vehicle. For example, a guiding rail may be attached to the vehicle that allows the storage apparatus to be secured in a variety of locations within the vehicle based upon location on the guiding rail.

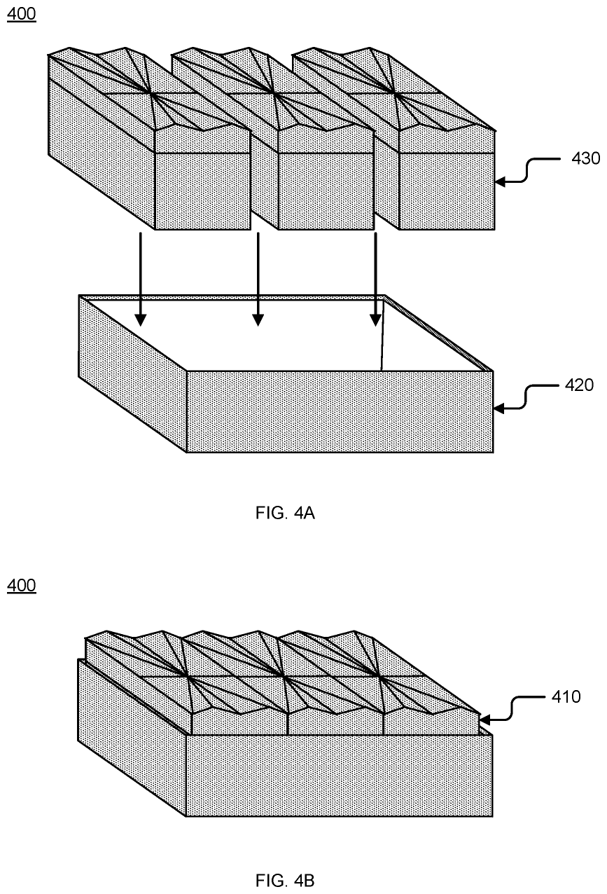

Referring now to FIG. 4A, an exemplary storage apparatus 400 comprising a container 420 with multiple sub-containers 430 is illustrated. In some embodiments, the sub-containers may possess separate lids that create the collective lid 410 of the storage apparatus 400. In some implementations, the lid 410 may be segmented to allow for partial opening. In some aspects, a device controlling which sections of the lid 410 may open simultaneously may exist for the user to select which sections of the lid 410 may open. In some embodiments, the sub-containers 430 may possess separate lids and the storage apparatus 400 may possess a lid 410 that covers all sub-container lids.

In some aspects, a lid 410 that may cover the sub-containers may allow for a reinforced and strong exterior without requiring each sub-container to comprise a lid with the same durability. Referring now to FIG. 4B, the sub-containers 430 may vary in size and quantity. For example, some sub-containers 430 may be sized to fit smaller objects such as a purse and may be positioned alongside a sub-container 430 that may be larger to allow for the placement of larger objects such as work clothing. In some implementations, a lid 410 may connect the sub-containers 430, which may secure the sub-containers 430 within the container 420.

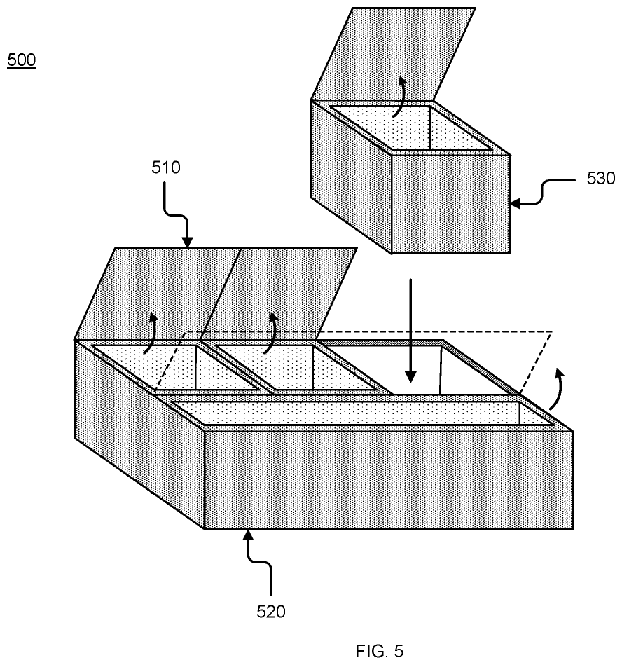

Referring now to FIG. 5, an exemplary storage apparatus 500 comprising a number of sub-containers 530 is illustrated. In some aspects, sub-containers 530 may differ in size, wherein sub-containers 530 may be mixed and match to fit into the container 520. This may allow a user to customize the container 530 to their needs and preferences. For example, where a user may transport multiple files, the user may configure the sub-containers 520 to accept file folders. In some embodiments, the sub-containers 530 may possess separate lids 510.

In some embodiments, the lid 510 may comprise a container lid 510 with sub-container lids that operate as two separate layers of lid. In some implementations, the container lid 510 may comprise the sub-container lids. In some aspects, the sub-containers 530 may utilize the container lid. For example, the sub-containers 530 may occupy a portion of the container 520 volume and the container lid 510 may cover the sub-containers 530 and the remaining volume within the container 520.

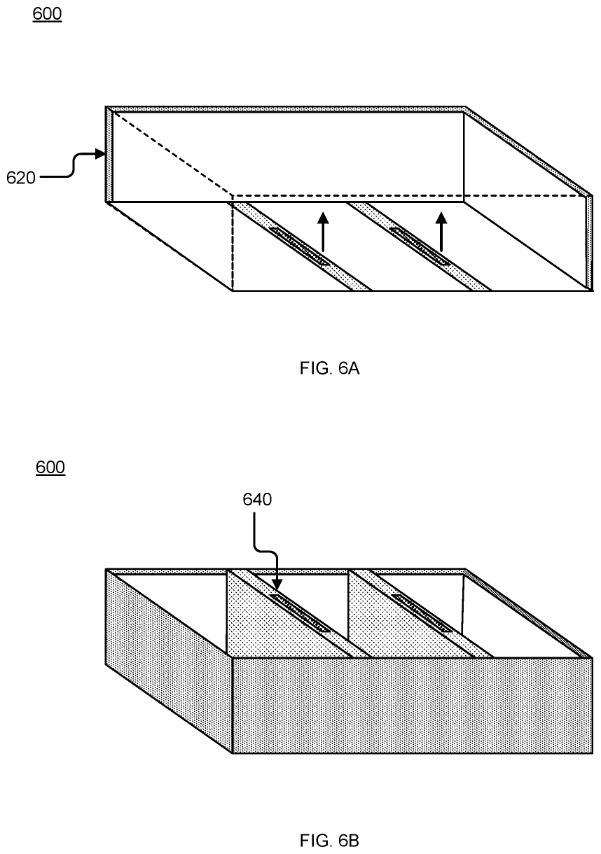

Referring now to FIG. 6A, an exemplary interior divider 640 is illustrated. In some embodiments, the storage apparatus 600 may comprise a container 620 divided by interior dividers 640. In some implementations, the interior dividers 640 may extend to a predetermined height. In some aspects, the interior dividers 640 may be complemented by additional interior dividers that may be perpendicular to the illustrated divider orientation, which may allow for customization of interior organization.

Referring now to FIG. 6B, an exemplary interior divider 640 is illustrated. In some embodiments, the interior dividers 640 may extend to the full height of the container 620. In some aspects, a container 620 may comprise a number of interior dividers configured in a number of locations within the interior 622 of the container 620 to allow for a variety of segmented space orientations.

In some embodiments, the interior dividers 640 may be adjusted by height utilizing an external positioning mechanism. For example, an interior divider 640 may alter height by sliding along attached guiding rails and may be secured at a height by a pin, as a non-limiting example. In another example, an interior divider may be adjusted between pre-determined heights using an external securing mechanism such as, but not limited to, an extruded spring-based pin that may be depressed for adjustment and extends into a depression or cavity at an intended height.

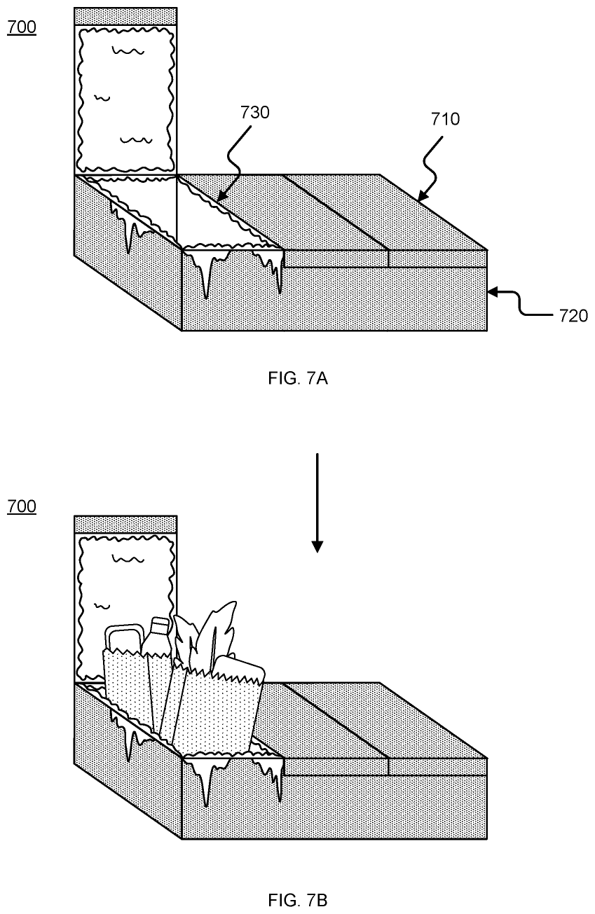

Referring now to FIG. 7A, an exemplary sub-container 730 with temperature control is illustrated. In some implementations, the sub-container 730 may be designed to maintain predefined temperatures that may differ from ambient temperature. For example, a cooler may be integrated with the storage apparatus 700 to store items with the purpose of maintaining an intended temperature. In some aspects, a third-party vendor may supply a sub-container 730 or may provide a secondary container that may fit into a sub-container 730. For example, a grocery store may provide a reusable grocery bag that may fit into a sub-container 730. As another example, a beverage store may provide segmenting panels that may be inserted into a sub-container 730, which may secure glass bottles within the sub-container.

Referring now to FIG. 7B, an example of a sub-container is illustrated. In some embodiments, the sub-container 730 may receive a power supply from an external source to perform a function. In some aspects, the power supply may receive power from a plug on the exterior of the container 720. In some implementations, the power supply may receive power from a power source embedded within the container. For example, solar panels attached to the lid 710 of the storage apparatus 700 may collect energy that charges a battery stored within the storage apparatus 700 that supplies internal power to a cooler sub-container to maintain a desired temperature.

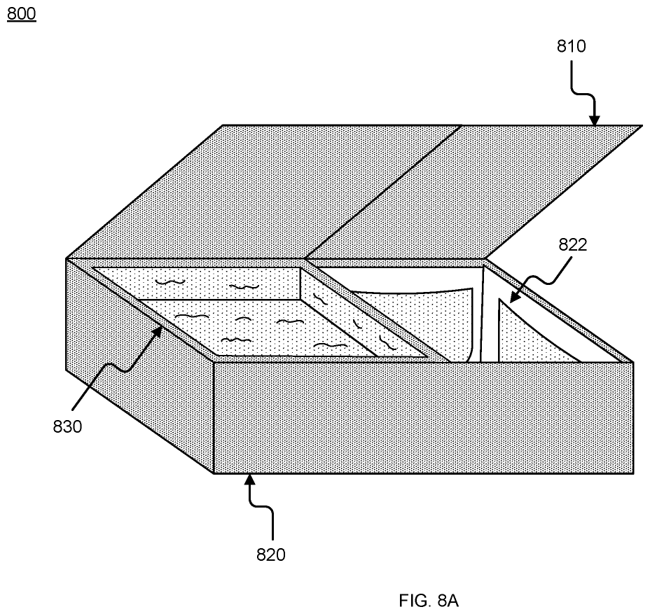

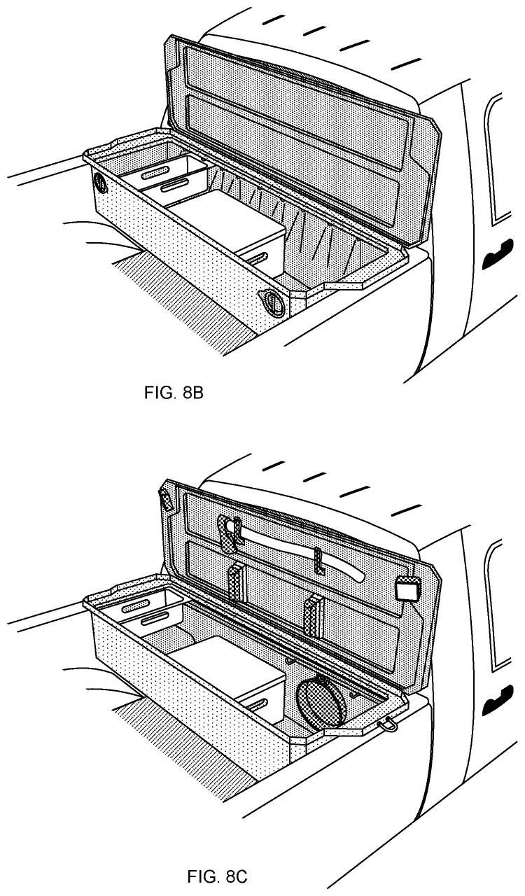

Referring now to FIG. 8A, an exemplary sub-container 830 of a limited size within the container 820 of the storage apparatus 800. In some embodiments, the sub-container 830 may be smaller in dimension than the volume within the container 820. For example, a sub-container for a laptop may be shallow, leaving unused area beneath the container. In some aspects, the unoccupied volume may remain unallocated to another sub-container and may function as a separate storage partition. In some implementations, the excess volume from a sub-container 830 may be complemented with a sub-container. In some embodiments, the interior 822 of the container 820 may contain small compartments such as, but not limited to, pockets to store additional objects.

Referring now to FIGS. 8B and 8C, exemplary interior configurations of storage apparatuses are illustrated. In some embodiments, interior configurations may be based on the needs of a user. For example, a camping configuration may allow for storage of objects associated with camping, such as first aid kit, fishing pole, and cooler. In some aspects, a storage apparatus may comprise a lighting mechanism, which may replace or enhance lighting installed on the truck. Lighting may allow for increased ability to view and access the storage apparatus and may support tailgating activities.

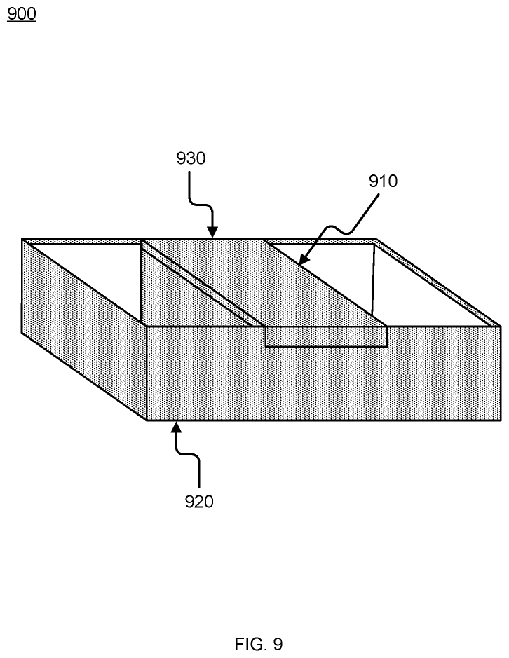

Referring now to FIG. 9, an exemplary container 900 with a number of sub-containers 930. In some aspects, the sub-containers may be repositioned for accessibility. In some implementations, the sub-container 930 may comprise a range of shapes and sizes, allowing for customized segmenting within a container 920. As an illustrative example, six sub-containers may fit into the sub-container 900, which may allow for smaller sections. The six sub-containers 930 may comprise various sizes to accommodate for a range of contents. A sub-container 930 may comprise slender dimensions that may be configured to hold a briefcase and file folders, wherein the sub-container 930 may be located on the driver side of the container 900, allowing for easy access. A user may frequently need to access this sub-container 930. Less used portions may be located centrally to the container 900, as those portions may be more difficult to access.

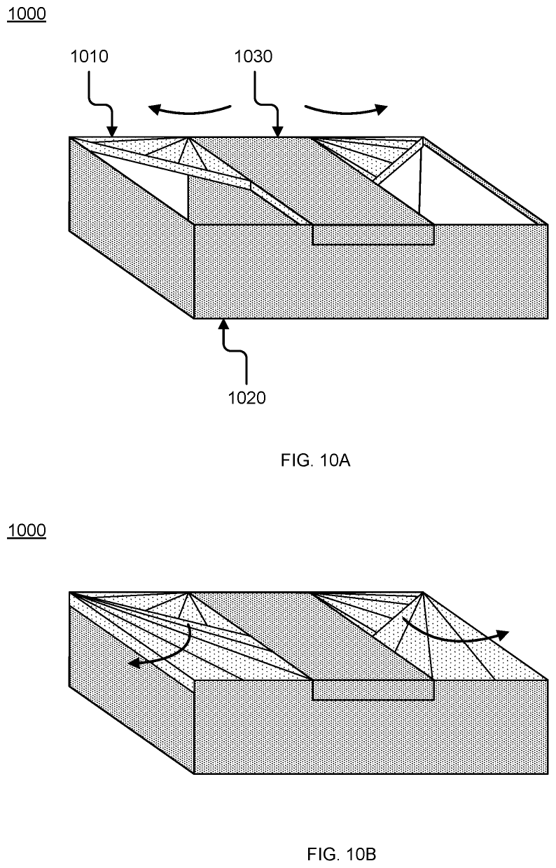

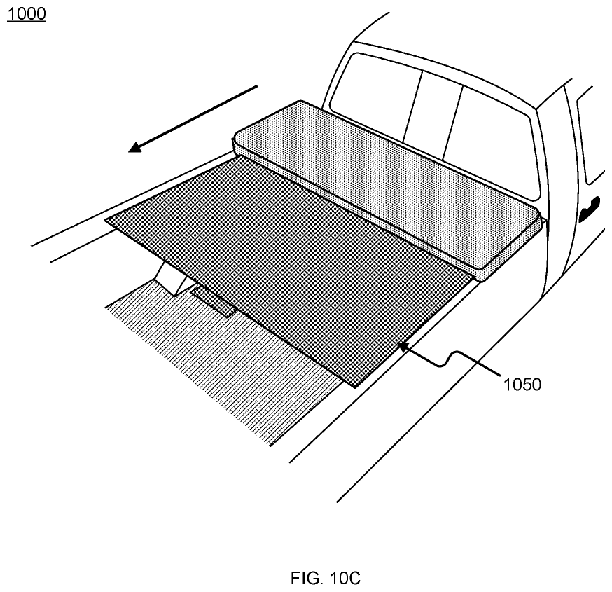

Referring now to FIG. 10A, an exemplary container with a number of sub-containers 1030 and lid 1010 configurations is illustrated. In some implementations, where there is vacant area within a container 1020, the lid 1010 may extend from the existing sub-container 1030 to allow for utilization of the vacant area of the storage apparatus 1000. In some implementations, the lid 1010 may enclose any sub-containers 1030 as a second top to the existing sub-container lid 1010. Referring now to FIG. 10B, an exemplary lid enclosing the storage apparatus is illustrated. In some aspects, the lid 1010 may ensure utilization of the entire storage apparatus 1000 when volume unclaimed by sub-containers 1030 may exist.

Referring now to 10C, an exemplary container 1000 with an extension panel 1050 is illustrated. In some embodiments, a container lid may comprise extension panel 1050 which may be extended to at least partially cover a portion of a vehicle, such as a truck bed. A truck bed cover 1050 may protect objects stored within the truck bed in addition to objects stored in the container.

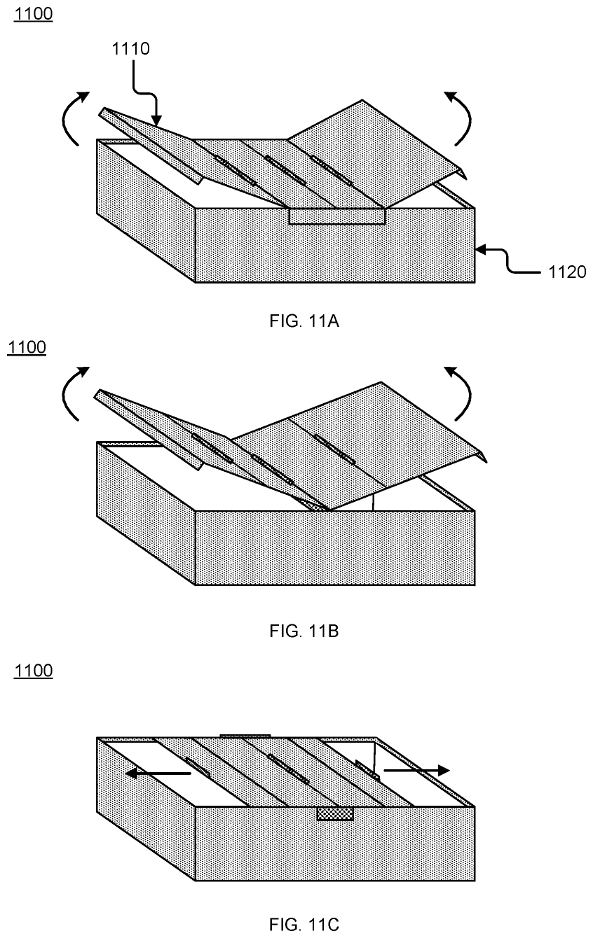

Referring now to FIG. 11A, an exemplary lid 1110 opening the storage apparatus 1100 via a variety of configurations is illustrated. In some embodiments, the lid 1110 may open from the sides of the storage apparatus 1100. In some aspects, the lid 1110 may bend at predetermined flexion points to allow for accessibility. In some implementations, the lid 1110 may open from the sides of the storage apparatus 1100 for portions closest to the sides of the vehicle and the lid 1110 may open from the front central location of the storage apparatus 1100 for the remaining access. This may allow for easy access to the storage apparatus 1100 without requiring a user to climb into the truck bed or reach across the storage apparatus 1100, which may be dirty or hot.

Referring now to FIG. 11B, an exemplary lid 1110 opening the container from the sides of the storage apparatus. In some embodiments, the lid 1110 may be segmented. For example, the lid 1110 may be divided in half to access the container 1120 from the sides of the storage apparatus 1100. In some implementations, the folding lines of the lid 1110 may be integrated into existing divisions of the lid 1110. For example, the lid 1110 in FIG. 11A may fold in half similar to FIG. 11B in addition to the existing segmentation of the lid 1110.

Referring now to FIG. 11C, an exemplary lid 1110 opening the storage apparatus 1100 is illustrated. In some embodiments, the lid 1110 may retract from the sides towards the center of the storage apparatus 1100 to display contents on each side of the storage apparatus 1100. In some aspects, the lid 1110 may open from the sides and remain a unified panel that may be opened from the front of the storage apparatus 1100. In some aspects, a device may control which sections of the lid 1110 may open simultaneously. For example, a user may be able to select which segment may open and the manner that the segment opens, such as illustrated between FIGS. 11B and 11C. The control may be mechanical, such as through a slide control that may connect or disconnect lid portions as needed. The control may be electronic where a remote or local controller may allow a user to configure how the lid 1100 operates.

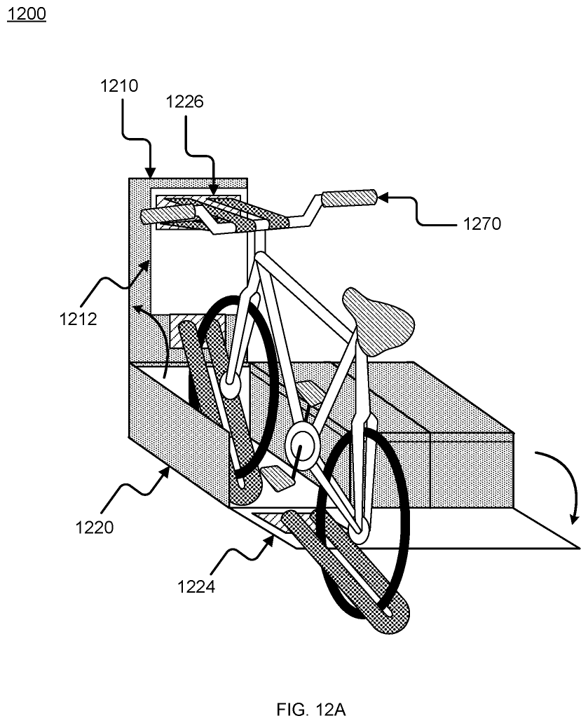

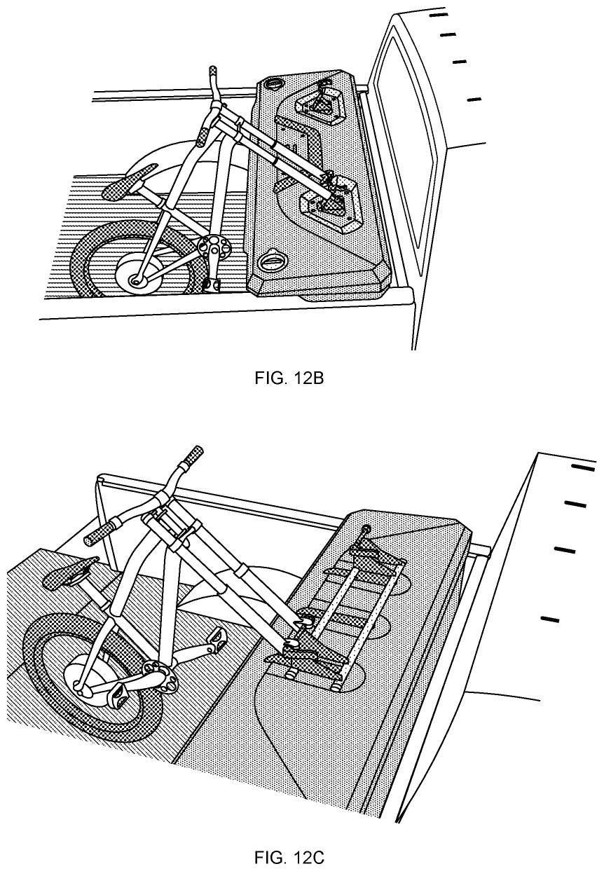

Referring now to FIG. 12A, an exemplary storage apparatus 1200 with a collapsing side panel 1224 is illustrated, wherein the collapsing side panel 1224 may accommodate storage of large objects such as, but not limited to, outdoors equipment 1270, tools, or furniture. In some embodiments, the container 1220 may contain interior securing locations 1226 for fastening objects to the storage apparatus 1200. In some aspects, the lid 1210 may be segmented to allow for visibility from the vehicle. For example, both sides of the lid 1210 may be extended to accommodate the securing of large objects such as, but not limited to, a bicycle while the center of the lid 1210 remains collapsed to allow for visibility from the vehicle. In some implementations, a lid 1210 may comprise a transparent window 1212 that may allow for visibility for a driver when the lid 1210 is in an open position.

In some embodiments, the lid 1210 may possess a mechanism to secure the lid 1210 in a static upright position. For example, the lid 1210 may possess a sliding rod that remains within the lid until the lid is extended to a perpendicular angle at which time the rod may slide into a slot or cavity, as non-limiting examples, attached to the container 1220. In some implementations, the lid 1210 may contain exterior anchor or securing location, as non-limiting examples, that may keep the lid 1210 in an open, fixed position. In some embodiments, the interior securing locations 1226 may be configured to hold specific pieces of equipment or equipment within predefined parameters, such as orientation, size, and shape.

Referring now to FIGS. 12B and 12C, exemplary exterior object securing mechanisms for a storage apparatus are illustrated. In some aspects, exterior object securing mechanisms may allow for storage of devices, such as bicycles. In some embodiments, exterior object securing mechanisms may allow for placement of devices in multiple locations.

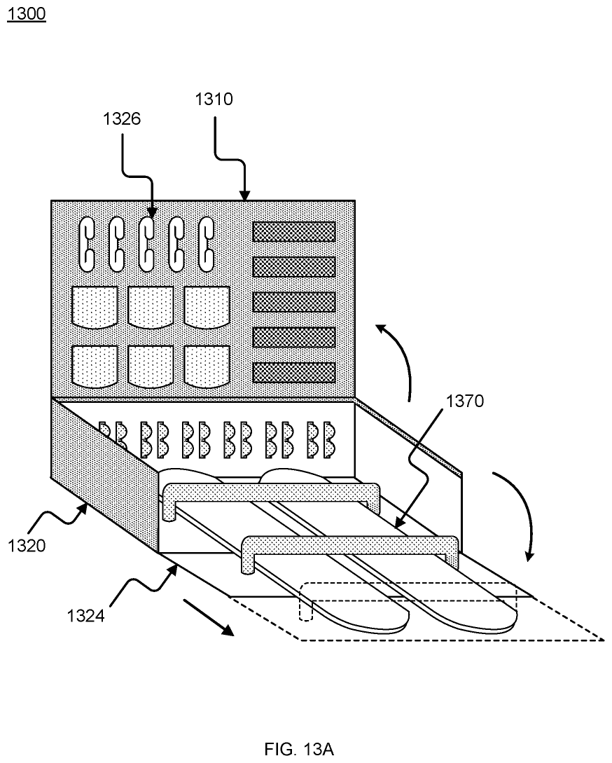

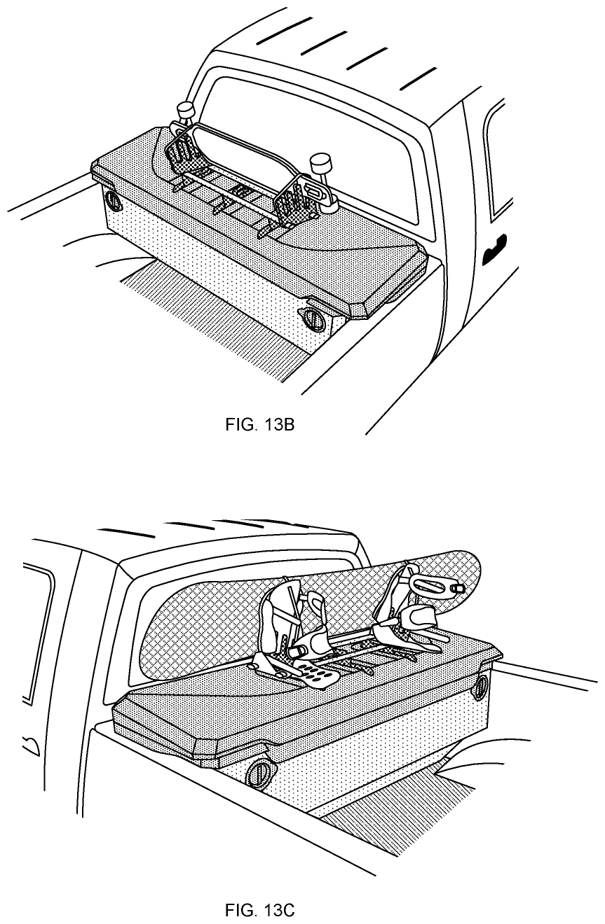

Referring now to FIG. 13A, an exemplary embodiment of interior securing locations within the storage apparatus 1300 and alteration of the container side panels 1324 is illustrated. In some implementations, the side panel 1324 of the container 1320 may collapse to allow for objects such as, but not limited to, outdoors equipment 1370 that may extend beyond the boundaries of the storage apparatus 1300. In some embodiments, the side panel 1324 may be secured to the container 1320 in an adjustable manner.

Referring now to FIGS. 13B and 13C, exemplary exterior object securing mechanisms for a storage apparatus are illustrated. In some aspects, equipment may be stored on the exterior of a storage apparatus, allowing for more storage in the interior of the storage apparatus. In some embodiments, exterior object securing mechanisms may be detachable based on need.

For example, and not limitation, the collapsible side panel 1324 may click in and out of place with the rest of the container 1320 by adjusting a slide and bolt at the edge between the side panel 1324 and the container 1320. In some aspects, the interior securing locations 1326 may comprise a number of object securing mechanisms or methods. For example, the interior securing locations 1326 may include object securing mechanisms in the form of straps for accessories, racks for flat boards, hooks for accessories, or rack allotments as non-limiting examples. In some embodiments, the side panel 1324 may extend beyond the original height to accommodate objects of greater length that may utilize the interior securing locations 1326. In some aspects, the extended side panel 1324 may contain securing locations with the intended purpose of securing the panel to the vehicle.

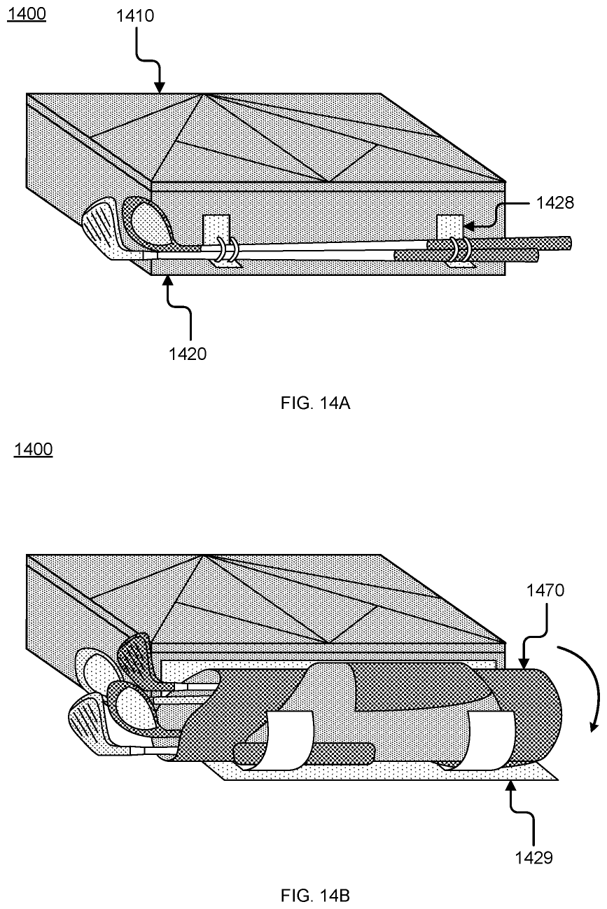

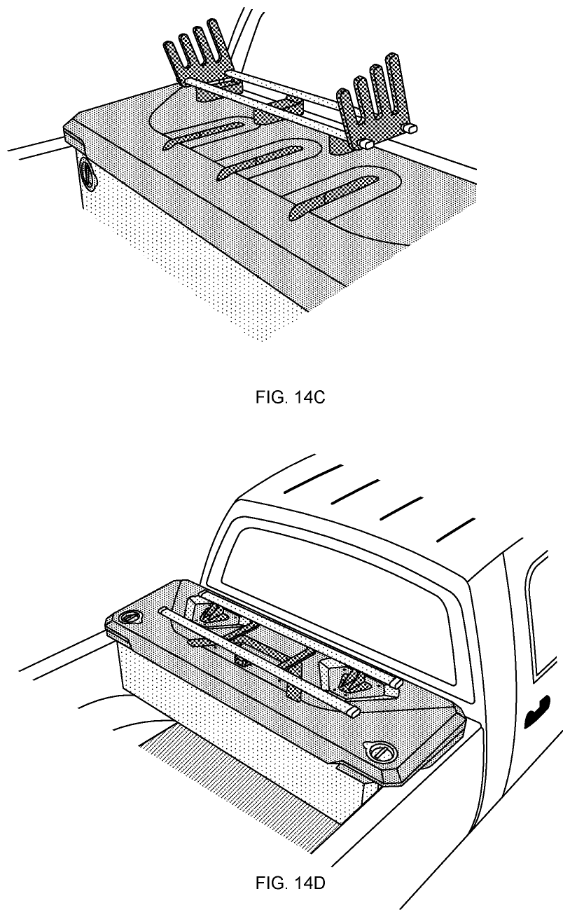

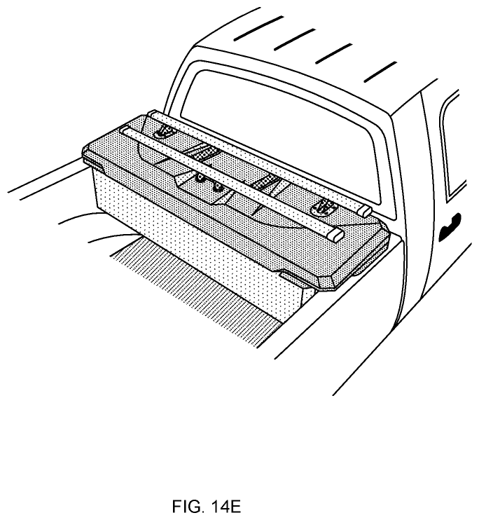

Referring now to FIG. 14A, an exemplary embodiment of exterior securing locations 1428 is illustrated. In some implementations, the exterior securing locations 1428 may include object securing mechanisms that exist within the side panel 1424 of the container 1420. For example, the exterior securing locations 1428 may extend from the container 1420 when a small amount of force is applied. In some implementations, the exterior securing locations 1428 may extend from the container 1420 by means of manual extension from an indented recess in the surface of the side panel 1424.

Referring now to FIG. 14B, an exemplary embodiment of exterior securing panel is illustrated. In some embodiments, the extension of the exterior securing panel may be an electronic response to a signal received by an external signal device. In some implementations, the power required by electronic automation may be supplied from an external source. In some embodiments, the power supplied for electronic automation may be supplied from an internal energy storage source. In some aspects, the exterior securing panel may be stabilized by an external support mechanism. For example, once the exterior securing panel is extended, a mechanism may extrude from the container or the panel to provide structural support.

Referring now to FIGS. 14C-14E, exemplary exterior securing panels for a storage apparatus are illustrated. In some aspects, configuration of exterior securing panels may allow for customization based on user needs. For example, a user transporting large pieces of equipment may prefer a larger exterior securing panel.

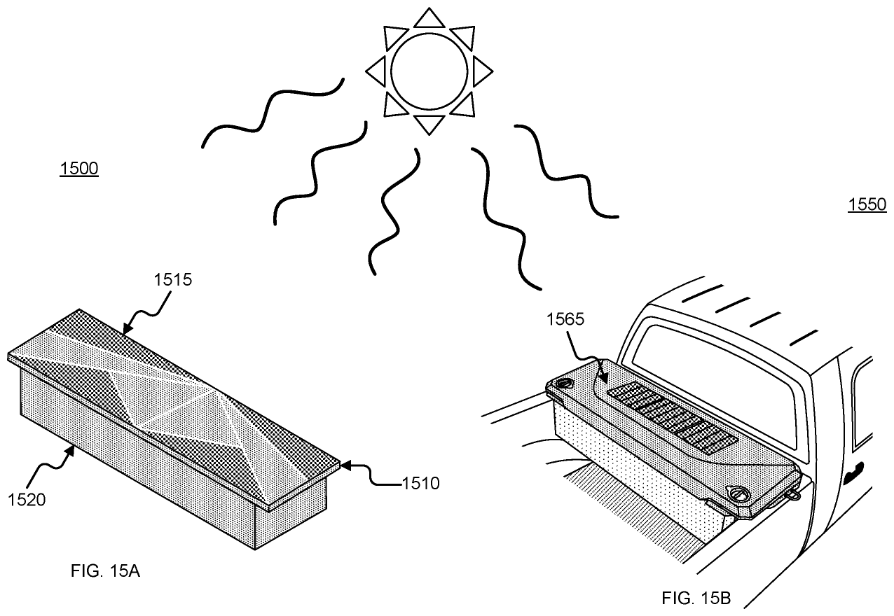

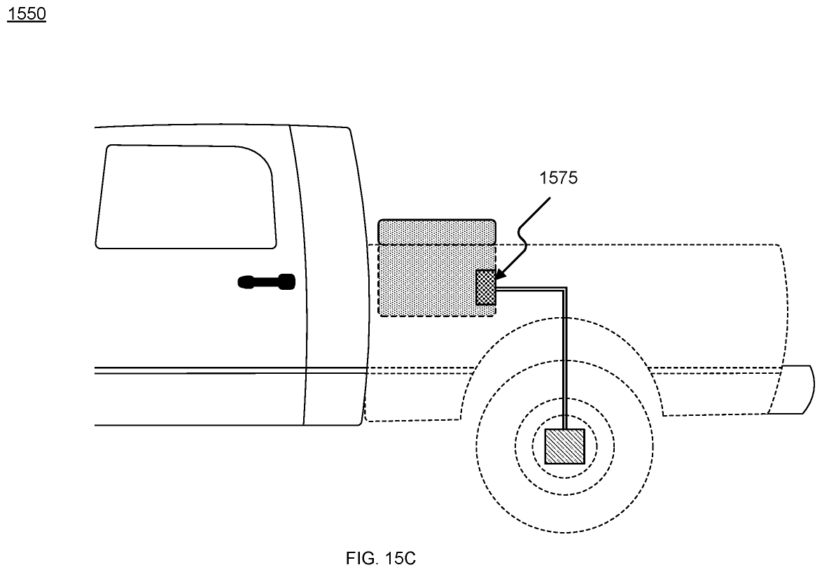

Referring now to FIGS. 15A-15C, an exemplary embodiment of power generating devices connected to the lid is illustrated. In some aspects, the power generating device 1515, 1565 may be attached to the lid 1510 in a removeable method. In some implementations, the power generated may be output to the storage apparatus 1500 to supply power to external devices, sub-containers that may utilize power to cool the sub-container, or internal systems such as work lights in the interior of the lid 1510 as non-limiting examples. In some embodiments, the power generating device 1575 may utilize kinetic energy generated by rotation of truck wheels during travel.

For example, and not limitation, the storage apparatus may contain external electrical ports for attaching cords designed to provide power to external devices. In some embodiments, the power generated may be stored in a power storage device. For example, a battery may be stored within the storage apparatus that may store an electrical charge. The battery may be removeable to use in a number of situations, such as to power equipment or machinery that may be stored in the storage apparatus. In some aspects, the power generating device may output the acquired power to the vehicle, such as to support a low battery of the truck, as a secondary supply of power for when the truck is not on, or to provide additional power outlets, as non-limiting examples.

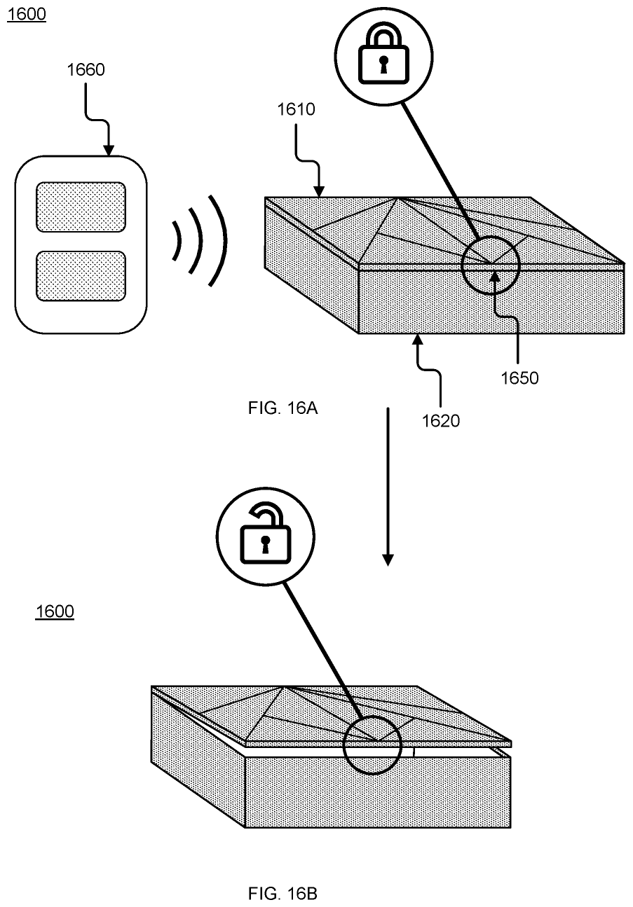

Referring now to FIG. 16A, an exemplary embodiment of securing system between the storage apparatus 1600 and an external signal device 1660 is illustrated. In some aspects, the storage apparatus may be secured utilizing a key lock, a combination lock, an electronic locking system as non-limiting examples. Referring now to FIG. 16B, an exemplary embodiment of securing mechanism 1650 between the storage apparatus 1600 and an external signal device 1660 is illustrated. In some embodiments, manual control of the securing mechanism 1650 may control whether the external signal device 1660 may have permission to operate the storage apparatus. For example, a user may be able to lock the storage apparatus 1600 and deny permission for remote access.

In some implementations, an electronic locking mechanism 1650 may lock when directed by an external signal device 1660. In some aspects, the external signal device 1660 may be integrated into existing systems within the vehicle. For example, the button required to unlock the storage apparatus may be embedded within the cabin of the vehicle similar to integrated garage door openers, where the storage apparatus opener may be synched with an internal control panel. In some embodiments, the external signal device 1660 may unlock the storage apparatus when proximal to the storage apparatus 1600, such as exemplary embodiments wherein the external signal device 1660 may comprise a key fob with a proximity sensor. In some implementations, an electronic locking mechanism 1650 may lock when directed by an external signal device 1660, such as, for example and not limitation, in implementations wherein the external signal device 1660 may take the form of a remote-control device with at least one button.

In some embodiments, the electronic locking mechanism 1650 may be powered from an external source. The external source may provide charge to an electrical charge storage device that then distributes energy to the locking mechanism 1650 as needed. In some aspects, the electronic locking mechanism 1650 may be powered by an internal power source. For example, solar panels may be attached to the lid 1610 that store power within an electrical charge storage device which is used to provide power to the locking mechanism 1650.

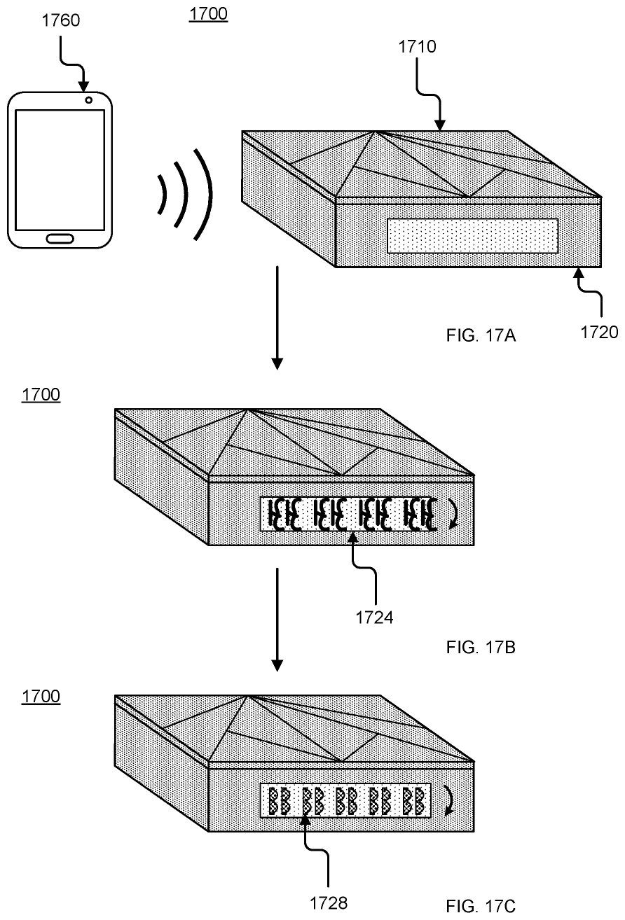

Referring now to FIG. 17A, an exemplary embodiment of altering storage apparatus 1700 configuration utilizing an external signal device 1760 is illustrated. In some embodiments, an external signal device 1760 may provide options for configuring the available securing locations and associated object securing mechanisms. In some aspects, the container 1720 may contain a number of securing locations. In some embodiments, these securing locations 1728 may be embedded within a side panel 1724 that may rotate in response to signals received by an external signal device 1760.

Referring now to FIG. 17B, an exemplary embodiment of an external securing location 1728 is illustrated. In some aspects, the hidden portions of a rotating panel of external securing locations 1728 may be stored within the container 1720. Referring now to FIG. 17C, an exemplary embodiment of an external securing location 1728 is illustrated. In some implementations, the panel 1724 may possess an attachment feature to attach the external securing locations 1728. For example, a bike rack attachment may be connected to the front panel of the storage apparatus and other securing location 1728 options may be stored within the storage apparatus 1700.

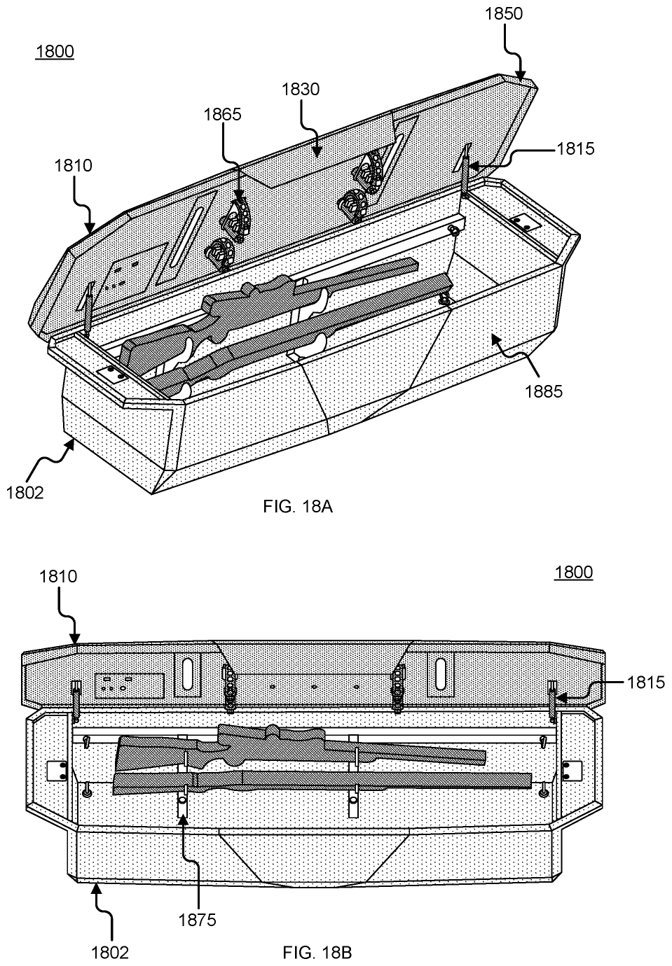

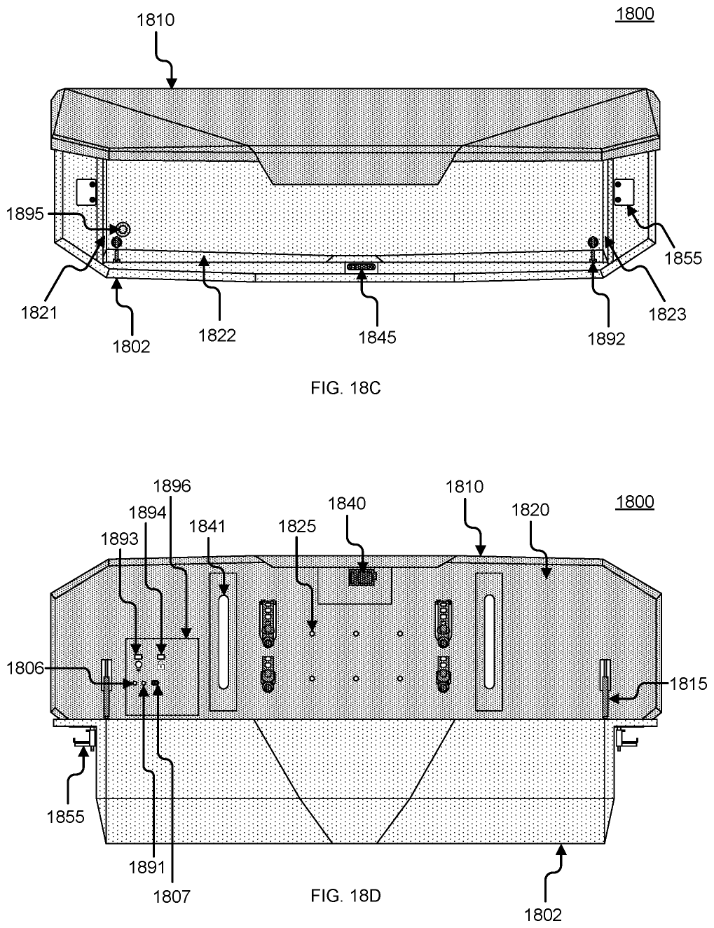

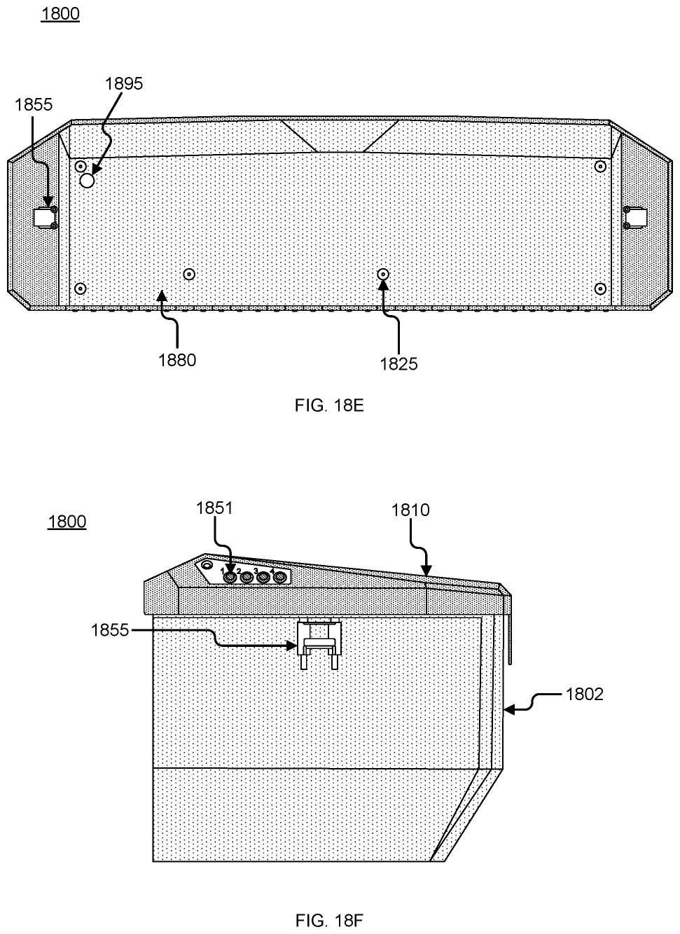

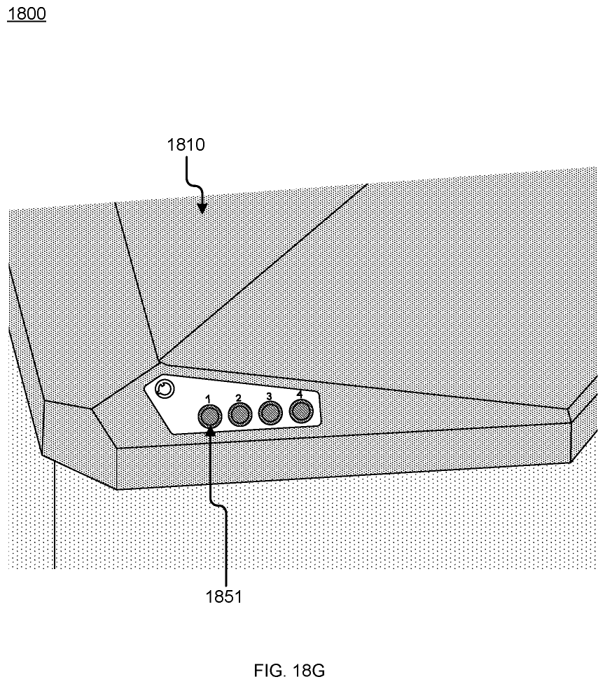

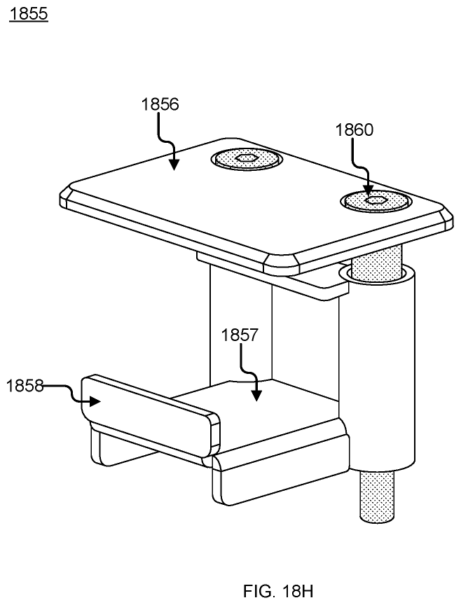

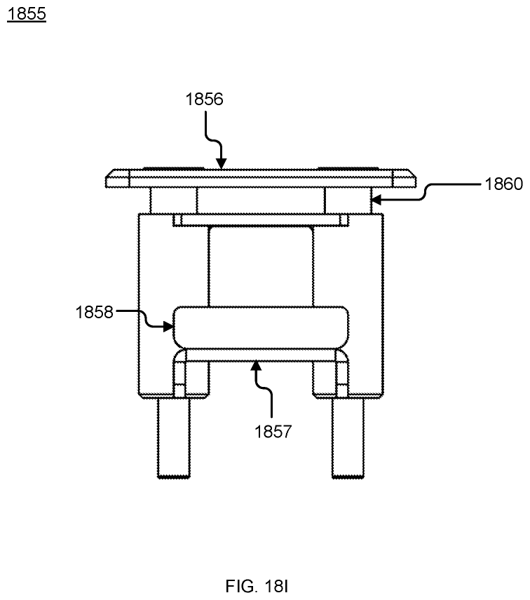

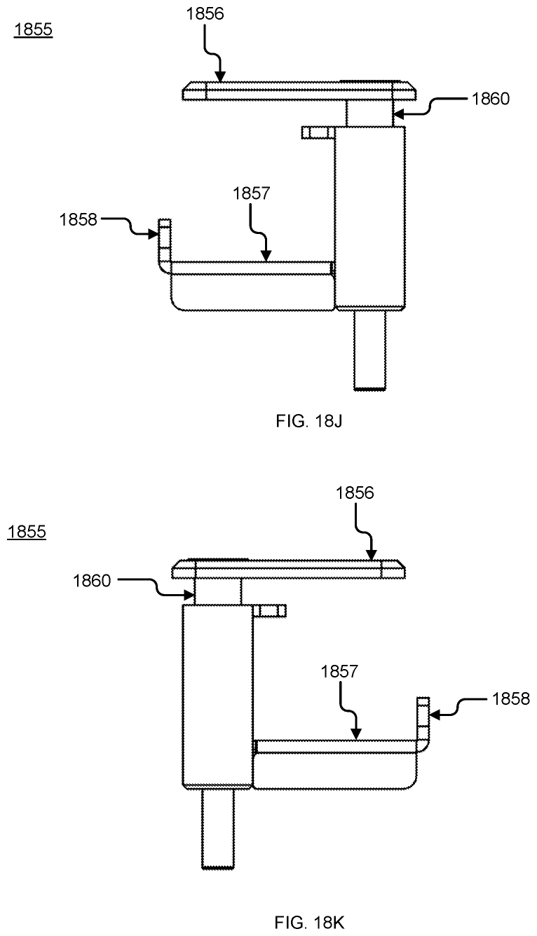

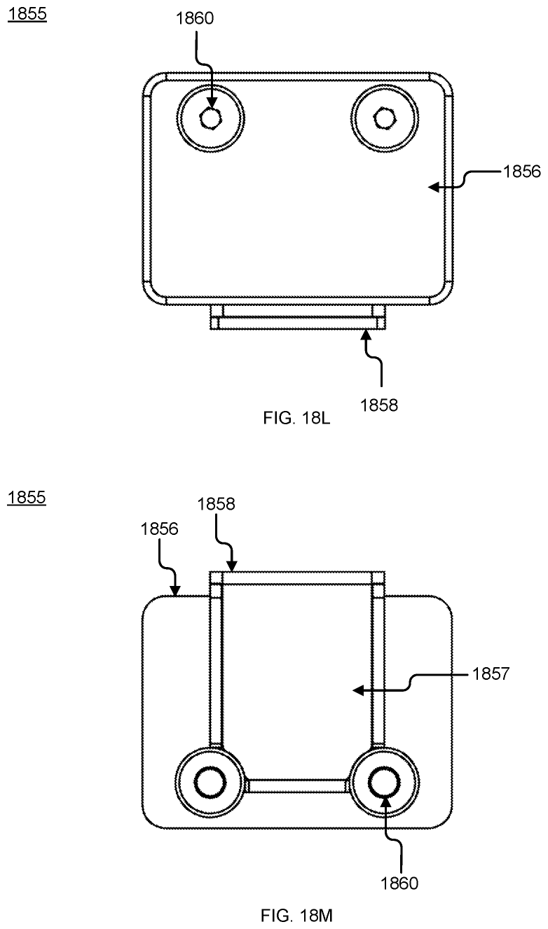

Referring now to FIGS. 18A-M, various views of various portions of an exemplary storage apparatus 1800, according to some embodiments of the present disclosure, are illustrated. In some aspects, the storage apparatus 1800 may comprise at least one lid 1800 and at least one container 1802. In some implementations, the container 1802 may comprise a base 1880, at least three side panels 1885 (shown as four side panels 1885 in FIGS. 18A-F), and a substantially open top portion. In some aspects, the lid 1810 may be alterable between an open position and a closed position, wherein the lid 1810 may physically cover the substantially open top portion when in the closed position. In some embodiments, the lid 1810 may comprise a variable surface, which may increase durability and limit damage to the lid 1810. By way of example and not limitation, the lid 1810 may comprise an outer surface with at least one type of variable surface or protruding structure, such as a bump, point, ridge, raised edge, raised panel, or combination thereof.

In some implementations, the lid 1810 may be configured to move between the open position and the closed position by pivoting about an axis via one or more hinges 1811. In some non-limiting exemplary embodiments, the hinges 1811 may be configured at a rear portion of the storage apparatus 1800 to connect a rear side of the lid 1810 to an upper portion of a rear side panel 1885. In some aspects, the storage container 1800 may comprise one or more actuators 1815 configured to facilitate movement of the lid 1810 between the open portion and the closed position. In some implementations, the actuators 1815 may be configured to operate in at least partially automated fashion when directed by at least one external signal device and/or at least one controller configured within at least one portion of the storage apparatus 1800, wherein the external signal device may comprise, for example and not limitation, a remote-control device, a key fob, or a computing device, such as a smartphone. By way of example and not limitation, each actuator 1815 may comprise a gas strut, hydraulic piston, spring-based mechanism, or any similar device, wherein a first end of each actuator 1815 may be at least temporarily secured to the lid 1810 and a second end of each actuator 1815 may be at least temporarily secured to an upper portion of at least one of the side panels 1885.

In some aspects, one or more portions of the storage apparatus 1800 may at least partially comprise one or more insulating materials. By way of example and not limitation, an internal portion of the lid 1810 and/or an internal portion of one or more of the side panels 1885 may at least partially comprise an amount of one or more internally injected materials to add insulation and/or rigidity to the storage apparatus 1800. As a non-limiting illustrative example, the lid 1810 and/or one or more of the side panels 1885 may at least partially comprise an amount of internally injected high density polyurethane foam that may provide both an insulating effect and enhanced rigidity to the storage apparatus 1800. In some non-limiting exemplary implementations, one or more portions of the storage apparatus 1800, such as the lid 1810, base 1880, and/or one or more of the side panels 1885 may at least partially comprise one or more sound dampening or sound absorbing materials, such as, for example and not limitation, rubber, cotton, acoustic foam, or carpet, to minimize or muffle noises caused by one or more items within the storage apparatus 1800 or by the storage apparatus 1800 itself.

In some embodiments, the lid 1810 and/or one or more of the side panels 1885 may each comprise an interior surface 1820, 1821, 1822, 1823. In some implementations, one or more of the interior surfaces 1820, 1821, 1822, 1823 and/or one or more portions of the base 1880 may comprise one or more holes, apertures, notches, indentations, or similar receiving elements comprising object securing locations 1825 configured to removably or permanently receive one or more fastening elements or similar object securing mechanisms 1892 configured to at least temporarily secure one or more items, objects, structures, or devices to one or more of the interior surfaces 1820, 1821, 1822, 1823 and/or the base 1880. By way of example and not limitation, the object securing locations 1825 may comprise one or more holes or attachment points configured to at least temporarily receive one or more mounting brackets 1865; one or more bolts, screws, pins, nails, or similar fastening elements configured to secure one or more storage trays drawers, storage racks 1875, or similar components; or at least a portion of at least one modular lightweight load-carrying equipment (or “MOLLE”) panels. In some aspects, the fastening elements may be removably secured to the object securing locations 1825 to facilitate modular usage of any items, objects, structures, or devices that may be secured therewith.

In some aspects, the lid 1810 may be configured to resist attempts at theft or tampering. In some non-limiting exemplary implementations, at least one portion of the lid 1810, such as, for example and not limitation, a front portion of the lid 1810 that opposes the rear portion, may comprise at least one downward-projecting protrusion, such as a tabular protruding element 1830, configured to extend from the lid 1810 to an exterior surface 1835 of at least one of the side panels 1885 to form a physical barrier that may block access to at least one latching mechanism 1840 integrated with or attached to the lid 1810 and configured to at least temporarily secure the lid 1810 in the closed position when the latching mechanism 1840 is received by at least one latch receiver 1845 configured upon or within an upper portion of one or more of the side panels 1885. In some aspects, the protruding element 1830 may inhibit the ability of the lid 1810 to be pried open, thereby increasing the secure nature of the storage apparatus 1800. In some embodiments, at least a portion of the outer edge of the lid 1810 may comprise a downward-projecting lip 1850 configured to be parallel to an outer edge 1855 of at least a portion of the top portion of the container 1802 when the lid 1810 is in the closed position, wherein the lip 1850 may extend at least partially beyond the uppermost surface of the top portion of the container 1802 to physically block the region where the lid 1810 contacts the uppermost surface of the top portion of the container 1802 when the lid 1810 is in the closed position, thereby inhibiting the ability of the lid 1810 to be pried open.

In some implementations, the storage apparatus 1800 may comprise at least one storage apparatus securing device configured to at least temporarily secure the storage apparatus 1800 to at least a portion of a vehicle. In some non-limiting exemplary embodiments, the storage apparatus securing device may comprise at least one clamp bracket 1855. In some aspects, the clamp bracket 1855 may be configured to at least temporarily secure the storage apparatus 1800 to at least a portion of a vehicle. As a non-limiting illustrative example, the clamp bracket 1855 may be configured to secure the storage apparatus 1800 within the bed of a pickup truck. In some non-limiting exemplary implementations, the clamp bracket 1855 may comprise a top portion 1856 and a bottom portion 1857. In some aspects, the top portion 1856 may comprise a substantially planar member configured to physically contact the top surface of the lid 1810 and the top portion of at least a portion of a vehicle, such as, for example and not limitation, the top surface of a sidewall of a truck bed. In some embodiments, the bottom portion 1857 of the clamp bracket 1855 may comprise a substantially planar portion as well as an upward-projecting lip 1858. In some implementations, the clamp bracket 1855 may comprise one or more securing elements 1860, such as, for example and not limitation, bolts or screws, wherein the securing elements 1860 may be configured to at least temporarily secure the clamp bracket 1855 to the storage apparatus 1800 and wherein the securing elements 1860 may be configured to facilitate an alteration of the distance between the top portion 1856 and the bottom portion 1857 of the clamp bracket 1855 such that increasing the distance may release the clamp bracket 1855 from the vehicle and decreasing the distance may facilitate securing of the clamp bracket 1855 and the securing apparatus 1800 to the vehicle.

As a non-limiting illustrative example, the clamp bracket 1855 may be configured to at least temporarily secure the storage apparatus 1800 within the bed of a pickup truck. After placing the storage apparatus 1800 at a desired location, a user may use a tool, such as, for example and not limitation, a screwdriver or hex wrench, to tighten one or more securing elements 1860 in the form of screws or bolts so that the top portion 1856 is drawn closer to the bottom portion 1857 of a clamp bracket 1855 configured within a horizontally-oriented extension configured on at least one side of an upper portion of the container 1802, thereby causing the clamp bracket 1855 to securely grasp an upper portion of a sidewall of the truck bed. In some aspects, once secured, removal of the storage apparatus 1800 from the truck bed may be difficult without the use of at least one tool or a significant amount of applied force, thereby making removal of the storage apparatus 1800 from the vehicle by unauthorized users more difficult.

In some implementations, an interior surface 1821, 1822, 1823 of one or more of the side panels 1885 and/or at least a portion of the base 1880 may comprise one or more elements or components configured to increase the utility of the container 1802 and the storage apparatus 1800. By way of example and not limitation, one or more of the interior surfaces 1821, 1822, 1823 may comprise one or more object securing mechanisms 1892 in the form of hooks, clamps, clasps, pins, straps, or eye bolts configured to at least temporarily receive one or more items, objects, structures, or devices, such as, for example and not limitation, different types of cargo, cargo nets, or component pouches. In some aspects, the base 1880 may comprise at least one removable drain plug 1895 that, when removed, unblocks at least one opening or aperture such that liquid or small debris particles such as sand, dirt, food crumbs, or other waste may be more easily removed from the container 1802.

In some aspects, the storage apparatus 1800 may comprise at least one self-contained electronic system. In some non-limiting exemplary implementations, the electronic system may comprise at least one controller and at least one power source, such as, for example and not limitation, at least one rechargeable battery, that may be configured within at least one housing 1896. By way of example and not limitation, the housing 1896 may be configured within an internal portion of the lid 1810. In some embodiments, an interior surface 1820, 1821, 1822, 1823 of the lid 1810 and/or one or more of the side panels 1885 may comprise one or more electrical ports, sockets, or outlets configured to allow an electrical current to flow from the storage apparatus 1800 to one or more external devices or to one or more batteries within the storage apparatus 1800 from one or more external power sources. By way of example and not limitation, the storage apparatus 1800 may comprise a 12-volt charging port 1806 and/or a 120-volt charging port 1807 configured to receive an electrical current from at least one external power source.

In some embodiments, the electrical system of the storage apparatus 1800 may comprise at least one power source. By way of example and not limitation, the power source may comprise one or more rechargeable batteries, one or more photovoltaic cells, or a wired connection 1831 to an electrical system of a vehicle, such as a hardwired 12-volt connection. In some implementations, the electrical system of the storage apparatus 1800 may comprise one or more lighting mechanisms 1841 and/or at least one electronic locking mechanism. In some aspects, the electronic locking mechanism may be configured to be altered between a locked state and an unlocked state, wherein the latch receiver 1845 may be configured to only release the latching mechanism 1840 when the electronic locking mechanism is in the unlocked state.

In some implementations, the electronic locking mechanism may be altered between the locked state and the locked state via at least one input device 1851, such as a keypad, keyboard, biometric scanner, microphone, or touchscreen, as non-limiting examples. In some non-limiting exemplary embodiments, the input device 1851 may be integrated within a portion of the lid 1810. In some aspects, a user may be required to enter a passcode or password or enter at least one voice sample or biometric input via the input device 1851, wherein receiving sufficient, adequate, or correct user input may cause at least one controller of the storage apparatus 1800 communicatively coupled to the input device 1851 and the electronic locking mechanism to alter the electronic locking mechanism between the locked state and the unlocked state. In some non-limiting exemplary embodiments, after a predetermined maximum number of incorrect entries, the input device 1851 may be rendered unusable for a period of time. By way of example and not limitation, the input device 1851 may be rendered unusable for 5, 15, or 30 minutes after three incorrect or insufficient entries have been received by the input device 1851. In some aspects, a user may be able to use a physical key to manually override or manipulate the electronic locking mechanism to alter the lock between the locked state and the unlocked state without using the input device 1851.

In some non-limiting exemplary embodiments, the lighting mechanisms 1841 may be communicatively coupled to at least one sensing device 1891 via at least one controller, wherein the sensing device 1891 may comprise, for example and not limitation, a motion detector, wherein the controller may be configured to alter the lighting mechanisms 1841 between an on state and an off state based at least partially on one or more inputs received from the sensing device 1891. In some implementations, each lighting mechanism 1841 may comprise an elongated structure integrated with or secured to the interior surface 1820 of the lid 1810. In some aspects, the lighting mechanisms 1841 may comprise one or more incandescent lights, one or more light-emitting diodes (or “LEDs”), or one or more fluorescent lights, as non-limiting examples. In some implementations wherein the lighting mechanisms 1841 and/or the electronic locking mechanism of the storage apparatus 1800 may be powered by one or more batteries, one or more interior surfaces 1820, 1821, 1822, 1823 of the lid 1810 or the side panels 1885 may comprise one or more indicators 1893, 1894 configured to display an amount of charge or power remaining within the batteries associated with the lighting mechanisms 1841 and/or the electronic locking mechanism, or an approximated amount of use time remaining before the batteries are no longer able to power the lighting mechanisms 1841 and/or the electronic locking mechanism, as non-limiting examples.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A storage apparatus configured to fit within a rear portion of a vehicle, the storage apparatus comprising:
a container comprising a base, at least three side panels, and a substantially open top portion; and
a lid configured to be altered between an open position and a closed position, wherein the lid physically covers the substantially open top portion when in the closed position, wherein the lid comprises an interior surface that comprises one or more object securing locations.

2. The storage apparatus of claim 1, wherein each of the one or more object securing locations comprises an indentation configured to removably receive one or more fastening elements.

3. The storage apparatus of claim 1, wherein the lid comprises an outer edge, wherein at least a portion of the outer edge comprises a downward-projecting lip configured to be parallel to an outer edge of a top portion of the container when the lid is in the closed position, wherein the lip extends at least partially beyond an uppermost surface of the top portion of the container to physically block a region where the lid contacts the uppermost surface of the top portion of the container when the lid is in the closed position.

4. The storage apparatus of claim 1, wherein an internal portion of the lid comprises an amount of one or more internally injected materials.

5. The storage apparatus of claim 4, wherein the one or more internally injected materials at least partially comprises high density polyurethane foam.

6. The storage apparatus of claim 1, wherein the lid is configured to move between the open position and the closed position by pivoting about an axis via one or more hinges that connect the lid to at least one of the at least three side panels, wherein the storage apparatus further comprises at least one actuator configured to facilitate movement of the lid between the open portion and the closed position.

7. The storage apparatus of claim 6, wherein a first end of the at least one actuator is at least temporarily secured to the lid and a second end of the at least one actuator is at least temporarily secured to at least one of the at least three side panels.

8. The storage apparatus of claim 7, wherein the at least one actuator comprises a gas strut.

9. A storage apparatus configured to fit within a rear portion of a vehicle, the storage apparatus comprising:
a container comprising a base, at least three side panels, and a substantially open top portion; and
a lid configured to be altered between an open position and a closed position, wherein the lid physically covers the substantially open top portion when in the closed position,
wherein the storage apparatus comprises a self-contained electronic system, wherein the electronic system comprises at least one controller and at least one power source.

10. The storage apparatus of claim 9, wherein the at least one controller and the at least one power source are configured within at least one housing within an internal portion of the lid.

11. The storage apparatus of claim 10, wherein the at least one power source comprises at least one rechargeable battery.

12. The storage apparatus of claim 9 wherein the electronic system further comprises at least one electronic locking mechanism that is alterable between a locked state and an unlocked state.

13. The storage apparatus of claim 12, wherein the lid comprises at least one latching mechanism and at least one of the at least three side panels comprises at least one latch receiver, wherein the at least one latch is configured be releasable from the at least one latch receiver only when the electronic locking mechanism is in the unlocked state.

14. The storage apparatus of claim 12, wherein the lid comprises at least one input device.

15. The storage apparatus of claim 14, wherein the at least one input device is configured to receive at least one user input, wherein receiving sufficient user input may cause the at least one controller to alter the at least one electronic locking mechanism between the locked state and the unlocked state.

16. The storage apparatus of claim 14, wherein the at least one input device comprises a keypad integrated with the lid.

17. The storage apparatus of claim 9, wherein the electronic system further comprises at least one lighting mechanism and at least sensing device, wherein the at least one lighting mechanism and the at least one sensing device are communicatively coupled to the at least one controller, wherein the at least one controller is configured to alter the at least one lighting mechanism between an on state and an off state based at least partially on one or more inputs received from the at least one sensing device.

18. A storage apparatus configured to fit within a rear portion of a vehicle, the storage apparatus comprising:
a container comprising a base, at least three side panels, and a substantially open top portion;
a lid configured to be altered between an open position and a closed position, wherein the lid physically covers the substantially open top portion when in the closed position, and
at least one storage apparatus securing device configured to at least temporarily secure the storage apparatus to the vehicle.

19. The storage apparatus of claim 18, wherein the at least one storage apparatus securing device comprises at least one clamp bracket, wherein the at least one clamp bracket comprises a top portion, a bottom portion, and one or more securing elements.

20. The storage apparatus of claim 19, wherein the one or more securing elements are configured to at least temporarily secure the at least one clamp bracket to the storage apparatus, wherein the one or more securing elements are further configured to facilitate an alteration of a distance between the top portion and the bottom portion of the at least one clamp bracket such that decreasing the distance secures the clamp bracket to at least a portion of the vehicle and increasing the distance releases the clamp bracket from the at least a portion of the vehicle.
